(19) United States
(12) Patent Application Publication
(10) Pub. No.: US 2024/0215573 A1
(43) Pub. Date: Jul. 4, 2024

(54) LIQUID AGROCHEMICAL COMPOSITION

(71) Applicant: NOURYON CHEMICALS INTERNATIONAL B.V., Amsterdam (NL)

(72) Inventors: Ralph FRANKLIN, Danbury, CT (US); Lei ZHANG, Chappaqua, NY (US); Shawn ZHU, Stormville, NY (US)

(73) Assignee: NOURYON CHEMICALS INTERNATIONAL B.V., Amsterdam (NL)

(21) Appl. No.: 18/254,444

(22) PCT Filed: Nov. 23, 2021
(86) PCT No.: PCT/EP2021/082721

§ 371 Date: May 25, 2023

Related U.S. Application Data
(60) Provisional application No. 63/118,766, filed on Nov. 27, 2020.

(51) Int. Cl. A01N 25/30; A01N 25/04; A01N 37/38; A01N 37/40; A01N 43/54; A01N 43/653; A01N 43/84; A01N 47/34; A01N 57/20; A01P 3/00; A01P 13/00

(52) U.S. Cl. CPC A01N 25/30; A01N 25/04; A01N 37/38; A01N 37/40; A01N 43/54; A01N 43/653; A01N 43/84; A01N 47/34; A01N 57/20; A01P 3/00; A01P 13/00

(57) ABSTRACT

A liquid agrochemical composition includes an agrochemical including a fungicide and/or an herbicide chosen from dicamba, 2,4-D, glufosinate, and combinations thereof and in an amount of from about 0.05 to about 60 weight percent based on a total weight of the composition; and
a surfactant in an amount of from about 0.05 to about 50 weight percent based on a total weight of the composition and consisting of;
(i) at least one alkoxylated monoglyceride in an amount of from about 30 to about 45 weight percent,
(ii) at least one alkoxylated diglyceride in an amount of from about 40 to about 50 weight percent,
(iii) at least one alkoxylated triglyceride in an amount of from about 8 to about 10 weight percent, and
(iv) at least one alkoxylated glycerin in an amount of from about 6 to about 8 weight percent, each based on a total weight of the surfactant.

### CROSS-REFERENCE TO RELATED APPLICATION

This application is a U.S. National-Stage entry under 35 U.S.C. § 371 based on International Application No. PCT/EP2021/082721, filed Nov. 23, 2021, which was published under PCT Article 21(2) and which claims priority to U.S. Application No. 63/118,766, filed Nov. 27 , 2020, which are all hereby incorporated in their entirety by reference.

### TECHNICAL FIELD

The present disclosure generally relates to liquid agrochemical compositions and more particularly relates to liquid agrochemical compositions that include a surfactant including particular amounts of an alkoxylated monoglyceride, an alkoxylated diglyceride, an alkoxylated triglyceride, and alkoxylated glycerine.

### BACKGROUND

It is well known that many herbicides and fungicides benefit from the presence of surfactants to improve bioefficacy and enhance overall performance. The surfactant may be included as part of a concentrated pesticidal formulation, or it may be added by the end user to the diluted spray solution.

The choice of surfactant is important since there are wide variations in the ability of surfactants to enhance pesticidal efficacy. The efficacy of herbicide, or fungicide, solutions can be highly dependent upon two factors: selecting a suitable surfactant and providing an effective amount of that surfactant in the formulation. While some existing surfactants that are currently used demonstrate excellent bioefficacy enhancing abilities, they can also be very irritating to the eyes. Alternatives having lower eye irritation properties and a lower toxicity to aquatic life would be advantageous.

It is known to those skilled in the art that finding a suitable surfactant with good efficacy enhancing property can be difficult. However, finding a suitable surfactant with low eye irritation and aquatic toxicity properties in addition to good efficacy enhancing property is even more difficult. Few known surfactants with good eye irritation and aquatic toxicity properties are currently used and most are not particularly efficacious across different herbicides and fungicides. The use surfactants based on natural and renewable materials would be a desirable feature Accordingly, there remains an opportunity for improvement. In addition, other objects, desirable features and characteristics will become apparent from the subsequent summary and detailed description, and the appended claims, taken in conjunction with the accompanying drawings and this background.

### BRIEF SUMMARY

This disclosure provides a liquid agrochemical composition including:
an agrochemical including a fungicide and/or an herbicide chosen from dicamba, 2,4-D, glufosinate, and combinations thereof and present in an amount of from about 0.05 to about 60 weight percent based on a total weight of the composition; and a surfactant present in an amount of from about 0.05 to about 50 weight percent based on a total weight of the composition and consisting of;
(i) at least one alkoxylated monoglyceride present in an amount of from about 30 to about 45 weight percent based on a total weight of the surfactant,
(ii) at least one alkoxylated diglyceride present in an amount of from about 40 to about 50 weight percent based on a total weight of the surfactant,
(iii) at least one alkoxylated triglyceride present in an amount of from about 8 to about 10 weight percent based on a total weight of the surfactant, and
(iv) at least one alkoxylated glycerin present in an amount of from about 6 to about 8 weight percent based on a total weight of the surfactant.

This disclosure also provides a liquid agrochemical composition consisting essentially of:
an agrochemical including a fungicide and/or an herbicide chosen from dicamba, 2,4-D, glufosinate, and combinations thereof and present in an amount of from about 0.05 to about 60 weight percent based on a total weight of the composition; and
a surfactant present in an amount of from about 0.05 to about 50 weight percent based on a total weight of the composition and consisting of;
(i) at least one alkoxylated monoglyceride present in a molar amount of from about 30 to about 45 weight percent of the surfactant and has a structure

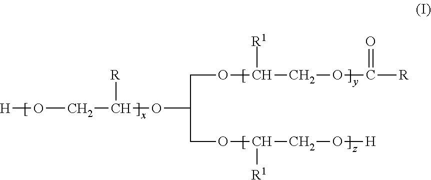

(ii) at least one alkoxylated diglyceride present in a molar amount of from about 40 to about 50 weight percent based on a total number of moles of (i)-(iv) in the surfactant and has a structure

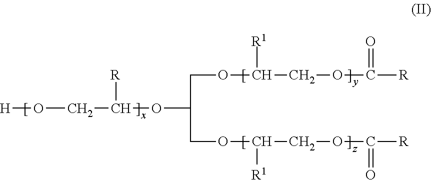

(iii) at least one alkoxylated triglyceride present in a molar amount of from about 8 to about 10 weight percent based on a total number of moles of (i)-(iv) in the surfactant and has a structure

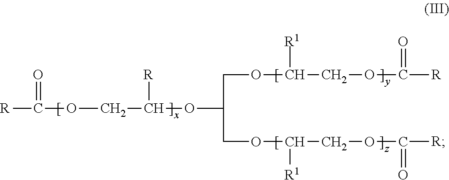

and
(iv) at least one alkoxylated glycerin present in a molar amount of from about 6 to about 8 weight percent based on a total number of moles of (i)-(iv) in the surfactant and has a structure

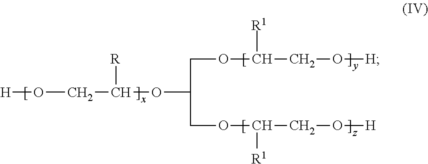

wherein each R is independently a C7-C23 saturated or unsaturated group;
wherein each R¹ is independently H, CH₃, or CH₂CH₃; and
wherein a total of (x+y+z) is from about 2 to about 40.

### DETAILED DESCRIPTION

The following detailed description is merely exemplary in nature and is not intended to limit the instant liquid agrochemical composition. Furthermore, there is no intention to be bound by any theory presented in the preceding background or the following detailed description. Moreover, it is contemplated that, in various non-limiting embodiments, it is to be appreciated that all numerical values as provided herein, save for the actual examples, are approximate values with endpoints or particular values intended to be read as “about” or “approximately” the value as recited.

Embodiments of the present disclosure are generally directed to liquid agrochemical compositions and methods for forming the same. For the sake of brevity, conventional techniques related to forming liquid agrochemical compositions may not be described in detail herein. Moreover, the various tasks and process steps described herein may be incorporated into a more comprehensive procedure or process having additional steps or functionality not described in detail herein. In particular, various steps in the manufacture of liquid agrochemical compositions are well-known and so, in the interest of brevity, many conventional steps will only be mentioned briefly herein or will be omitted entirely without providing the well-known process details.

This disclosure provides a liquid agrochemical composition. The terminology “liquid” describes that the composition is deemed a liquid (and not a solid) by those of skill in the art at a temperature of approximately 25° C. In various embodiments, the composition has a viscosity of from about 1 to about 70,000 cps determined at 25° C. using any suitable instrument, such as a Brookfield viscometer, wherein 1 cps is approximately the viscosity of water when determined using this method. In various embodiments, the viscosity is from about 1 to about 50,000, about 1 to about 25,000, about 1 to about 10,000, about 1 to about 5,000, about 1 to about 1,000, about 1 to about 100, about 100 to about 10,000, about 100 to about 5,000, about 100 to about 2,500, about 100 to about 1,000, about 100 to about 500, about 1,000 to about 25,000, about 1,000 to about 15,000, about 1,000 to about 10,000, about 1,000 to about 5,000, about 5,000 to about 70,000, about 5,000 to about 50,000, about 5,000 to 25,000, about 5,000 to about 10,000, about 10,000 to about 70,000, about 10,000 to about 50,000, about 25,000 to about 70,000, about 25,000 to about 50,000, or about 50,000 to about 70,000, cps determined at 25° ° C. using any suitable instrument, such as a Brookfield viscometer, wherein 1 cps is approximately the viscosity of water when determined using this method. In various non-limiting embodiments, all values and ranges thereof, both whole and fractional, including and between those set forth above, are hereby expressly contemplated for use herein.

In various embodiments, the composition includes:
an agrochemical including a fungicide and/or an herbicide chosen from dicamba, 2,4-D, glufosinate, and combinations thereof and present in an amount of from about 0.05 to about 60 weight percent based on a total weight of the composition; and
a surfactant present in an amount of from about 0.05 to about 50 weight percent based on a total weight of the composition and consisting of;
(i) at least one alkoxylated monoglyceride present in an amount of from about 30 to about 45 weight percent based on a total weight of the surfactant,
(ii) at least one alkoxylated diglyceride present in an amount of from about 40 to about 50 weight percent based on a total weight of the surfactant,
(iii) at least one alkoxylated triglyceride present in an amount of from about 8 to about 10 weight percent based on a total weight of the surfactant, and
(iv) at least one alkoxylated glycerin present in an amount of from about 6 to about 8 weight percent based on a total weight of the surfactant.

In various non-limiting embodiments, all values and ranges thereof, both whole and fractional, including and between those set forth above, are hereby expressly contemplated for use herein.

This disclosure also provides a liquid agrochemical composition consisting essentially of:
an agrochemical including a fungicide and/or an herbicide chosen from dicamba, 2,4-D, glufosinate, and combinations thereof and present in an amount of from about 0.05 to about 60 weight percent based on a total weight of the composition; and
a surfactant present in an amount of from about 0.05 to about 50 weight percent based on a total weight of the composition and consisting of;
(i) at least one alkoxylated monoglyceride present in a molar amount of from about 30 to about 45 weight percent of the surfactant and has a structure

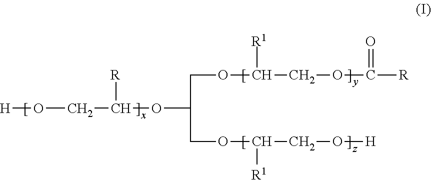

(ii) at least one alkoxylated diglyceride present in a molar amount of from about 40 to about 50 weight percent based on a total number of moles of (i)-(iv) in the surfactant and has a structure

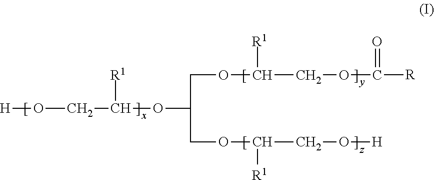

(iii) at least one alkoxylated triglyceride present in a molar amount of from about 8 to about 10 weight percent based on a total number of moles of (i)-(iv) in the surfactant and has a structure

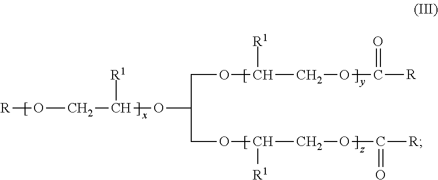

and
(iv) at least one alkoxylated glycerin present in a molar amount of from about 6 to about 8 weight percent based on a total number of moles of (i)-(iv) in the surfactant and has a structure

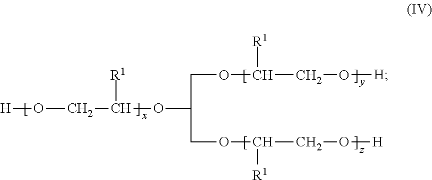

wherein each R is independently a C7-C23 saturated or unsaturated group;
wherein each R¹ is independently H, CH₃, or CH₂CH₃; and
wherein a total of (x+y+z) is from about 2 to about 40.

In various non-limiting embodiments, all values and ranges thereof, both whole and fractional, including and between those set forth above, are hereby expressly contemplated for use herein.

The agrochemical may be, include, consist essentially of, or consist of, a fungicide and/or an herbicide, e.g. chosen from dicamba, 2,4-D, glufosinate, and combinations thereof. However, it is contemplated that any herbicide can be used. The agrochemical may include an additional herbicide, such as a co-herbicide, in addition to the ones described above or may be free of any additional herbicide such as a co-herbicide. Moreover, a co-fungicide may be utilized. In one embodiment, one or more fungicides and/or co-fungicides may be combined with one or more herbicides and/or co-herbicides.

The terminology “consisting essentially of” describes embodiments that are free of (or include less than 5, 4, 3, 2, 1, 0.5, or 0.1, wt %) other agrochemicals that are not described herein. These may include, but are not limited to, pesticides, herbicides not described above, insecticides, rodenticides, etc. In one embodiment, the agrochemical may be, include, consist essentially of, or consist of, the fungicide. In another embodiment, the agrochemical may be, include, consist essentially of, or consist of, dicamba. In another embodiment, the agrochemical may be, include, consist essentially of, or consist of, the 2,4-D. In another embodiment, the agrochemical may be, include, consist essentially of, or consist of, glufosinate. In another embodiment, the agrochemical may be, include, consist essentially of, or consist of, combinations of dicamba, 2,4-D, and glufosinate (wherein is combination may or may not include a fungicide). In various non-limiting embodiments, all values and ranges thereof, both whole and fractional, including and between those set forth above, are hereby expressly contemplated for use herein.

The fungicide is not particularly limited and may be any known in the art. In various embodiments, the fungicide is chosen from acetamiprid, clothianidin, dinotefuran, imidacloprid, thiamethoxam, nitenpyram, azoles such as triticonazole, fluquinconazole, prothioconazole, difenoconazole, ipconazole, flutriafol and tebuconazole, thiophanate-methyl, prochloraz, pyraclostrobin, azoxystrobin, trifloxystrobin, orysastrobin, metalaxyl, dimethomorph, N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, N-(3′,4′-dichloro-5-fluorobiphenyl-2-yl)-3-difluoromethyl-1-methylpyrazole-4-carboxamide (common name bixafen), N-[2-(1,3-dimethylbutyl)-phenyl]-1,3-dimethyl-5-fluoro-1H-pyrazole-4-carboxamide, N-(2-bicyclopropyl-2-yl-phenyl)-3-difluoromethyl-1-methyl-1H-pyrazole-4-carboxamide (common name: sedaxane), N-[1,2,3,4-tetrahydro-9-(1-methylethyl)-1,4-methanonaphthalen-5-yl]-3-(difluoromethyl)-1-methyl-1H-pyrazole-4-carboxamide (common name: isopyrazam) and N-[2-(1,3-dimethylbutyl)-3-thienyl]-1-methyl-3-(trifluoromethyl)-1H-pyrazole-4-carboxamide (common name: penthiopyrad); and combinations thereof. In other embodiments, the fungicide may be chosen from genera triazoles, strobilurins, acylamino acids, pyrimidines, pyridines, arylphenyl ketones, amides, benzanilides, imidazoles, dinitrophenols, morpholines, phenylsulfamides and organophosphorus fungicides. Examples include benalaxyl, benlaxyl-M, bromuconazole, bupirimate, cyflufenamid, difenoconazole, dinobuton, dodemorph, dodemorph acetate, fenoxanil, flusilazole, flutolanil, imazalil, imibenconazole, ipconazole, isoprothiolane, kresoxim-methyl, mandipropamid, mepronil, metconazole, metrafenone, penconazole, picoxystrobin, prochloraz, pyraclostrobin, pyrazophos, silthiofam, tebuconazole, tolclofos-methyl, tolylfluanid, triadimefon, and trifloxystrobin. Suitable water-insoluble fungicides include benalaxyl, benlaxyl-M, dodemorph acetate, flutolanil, ipconazole, kresoxim-methyl, metconazole, picoxystrobin, pyraclostrobin, and tebuconazole, and combinations thereof.

In addition to the herbicides described above, the composition may include, or be free of, one or more co-herbicides including, but not limited to, aryloxyphenoxy-propionates (e.g., clodinafop-propargyl, diclofop-methyl, fenoxaprop-ethyl, fluazifop-butyl, haloxyfop-methyl, propaquizafop, quizalofop-ethyl), cyclohexanediones (e.g., butroxydim, clethodim, cycloxydim, sethoxydim, tralkoxydim), sulfonylureas (e.g., amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, halosulfuron, imazosulfuron, metsulfuron, oxasulfuron, primisulfuron, prosulfuron, pyrazosulfuron-ethyl, rimsulfuron, sulfosulfuron, thifensulfuron, triasulfuron, tribenuron, triflusulfuron), imadazolilines (e.g., imazamox), triazolopyrimidines (e.g., flumetsulam and metosulam), triazines (e.g., ametryn, atrazine, cyanazine, desmetryn, dimethametryn, prometon, prometryn, propazine, simazine, simetryne, terbumeton, terbuthylazine, terbutryn, trietazine), triazinone (e.g., hexazinone, metamitron, and metribuzin), uracils (e.g., lenacil and terbacil), pyridazinones (e.g., chloridazon), phenylcarbamates (e.g., desmedipham and phenmedipham), ureas (e.g., chlorotoluron, dimefuron, diuron, fenuron, fluometuron, isoproturon, isouron, linuron, methabenzthiazuron, metobromuron, metoxuron, monolinuron, neburon, siduron, and tebuthiuron), amides (e.g., propanil and pentanochlor), nitriles (e.g., bromofenoxim), bipyridyliums (e.g., diquat and paraquat), diphenylethers (e.g., bifenox, chlomethoxyfen, fluoroglycofen-ethyl, fomesafen, lactofen, and oxyfluorfen), phenylpyrazoles (e.g., pyraflufen-ethyl), N-phenylphthalimides (e.g., flumiclorac-pentyl), oxadiazoles (e.g., oxadiazon), triazolinones (e.g., azafenidin, carfentrazone-ethyl, and sulfentrazone), oxazolidinediones (e.g., pentoxazone), pyridazinones (e.g., norflurazon), pyridinecarboxamides (e.g., diflufenican), triketones (e.g., mesotrione and sulcotrione), isoxazoles (e.g., isoxaflutole), pyrazoles (e.g., benzofenap, pyrazolynate, and pyrazoxyfen), dinitroanilines (e.g., butralin, dinitramine, ethalfluralin, and pendimethalin), pyridines (e.g., dithiopyr), benzoic acids (e.g., chlorthal-dimethyl), carbamates (e.g., chlorpropham, propham, and carbetamide), chloroacetamides (e.g., acetochlor, alachlor, butachlor, and dimethachlor), nitriles (e.g., dichlobenil and chlorthiamid), benzamides (e.g., isoxaben), triazolocarboxamides (e.g., flupoxam), quinoline carboxylic acids (e.g., quinclorac), dinitrophenols (e.g., dinoterb), thiocarbamates (e.g., butylate, cycloate, dimepiperate, EPTC, esprocarb, molinate, orbencarb, pebulate, prosulfocarb, thiobencarb, tiocarbazil, triallate, and vernolate), phosphorodithioates (e.g., bensulide), benzofurans (e.g., benfuresate and ethofumesate), chlorocarbonic acids (e.g., TCA), phenoxycarboxylicacids (e.g., clomeprop, 2,4-DB, and MCPA), benzoic acids, quinoline carboxylic acids (e.g., quinclorac), phthalamate semicarbazones (e.g., naptalam), and arylaminopropionic acids (e.g., flamprop-methyl), acifluorfen, acrolein, amitrole, asulam, benazolin, bentazon, bialaphos, bromacil, bromoxynil, chloramben, chloroacetic acid, clopyralid, 4-(2,4-dichlorophenoxy)butanoic acid (2,4-DB), dalapon, dichlorprop, difenzoquat, diquat, endothall, fenac, fenoxaprop, flamprop, flumiclorac, fluoroglycofen, flupropanate, fomesafen, fosamine, imazameth, imazamethabenz, imazamox, imazapic, imazapyr, imazaquin, imazethapyr, ioxynil, 4-chloro-2-methylphenoxyacetic acid (MCPA), 4-(4-chloro-2-methylphenoxy)butanoic acid (MCPB), mecoprop, methylarsonic acid, naptalam, nonanoic acid, paraquat, picloram, quinclorac, sulfamic acid, 2,3,6-trichlorobenzoic acid (2,3,6-TBA), trichloroacetate (TCA), triclopyr and water-soluble salts thereof, acetochlor, aclonifen, alachlor, ametryn, amidosulfuron, anilofos, atrazine, azafenidin, azimsulfuron, benfluralin, benfuresate, bensulfuron-methyl, bensulide, benzofenap, bifenox, bromobutide, bromofenoxim, butachlor, butamifos, butralin, butroxydim, butylate, cafenstrole, carbetamide, carfentrazone-ethyl, chlomethoxyfen, chlorbromuron, chloridazon, chlorimuron-ethyl, chlornitrofen, chlorotoluron, chlorpropham, chlorsulfuron, chlorthal-dimethyl, chlorthiamid, cinmethylin, cinosulfuron, clethodim, clodinafop-propargyl, clomazone, clomeprop, cloransulam-methyl, cyanazine, cycloate, cyclosulfamuron, cycloxydim, cyhalofop-butyl, daimuron, desmedipham, desmetryn, dichlobenil, diclofop-methyl, diflufenican, dimefuron, dimepiperate, dimethachlor, dimethametryn, dimethenamid, dinitramine, dinoterb, diphenamid, dithiopyr, diuron, ethyl N,N-dipropylcarbamothioate (EPTC), esprocarb, ethalfluralin, ethametsulfuron-methyl, ethofumesate, ethoxysulfuron, etobenzanid, fenoxaprop-ethyl, fenuron, flamprop-methyl, flazasulfuron, fluazifop-butyl, fluchloralin, flumetsulam, flumiclorac-pentyl, flumioxazin, fluometuron, fluorochloridone, fluoroglycofen-ethyl, flupoxam, flurenol, fluridone, fluoroxypyr-1-methylheptyl, flurtamone, fluthiacet-methyl, fomesafen, halosulfuron, haloxyfop-methyl, hexazinone, imazamox, imazosulfuron, indanofan, isoproturon, isouron, isoxaben, isoxaflutole, isoxapyrifop, lactofen, lenacil, linuron, mefenacet, mesotrione, metamitron, metazachlor, methabenzthiazuron, methyldymron, metobenzuron, metobromuron, metolachlor, metosulam, metoxuron, metribuzin, metsulfuron, molinate, monolinuron, naproanilide, napropamide, naptalam, neburon, nicosulfuron, norflurazon, orbencarb, oryzalin, oxadiargyl, oxadiazon, oxasulfuron, oxyfluorfen, pebulate, pendimethalin, pentanochlor, pentoxazone, phenmedipham, piperophos, pretilachlor, primisulfuron, prodiamine, prometon, prometryn, propachlor, propanil, propaquizafop, propazine, propham, propisochlor, propyzamide, prosulfocarb, prosulfuron, pyraflufen-ethyl, pyrazolynate, pyrazosulfuron-ethyl, pyrazoxyfen, pyributicarb, pyridate, pyriminobac-methyl, quinclorac, quinmerac, quizalofop-ethyl, rimsulfuron, sethoxydim, siduron, simazine, simetryn, sulcotrione, sulfentrazone, sulfometuron, sulfosulfuron, tebutam, tebuthiuron, terbacil, terbumeton, terbuthylazine, terbutryn, thenylchlor, thiazopyr, thifensulfuron, thiobencarb, tiocarbazil, tralkoxydim, triallate, triasulfuron, tribenuron, trietazine, trifluralin, triflusulfuron, and vernolate, salts thereof, and combinations thereof.

In other embodiments, the co-herbicide may include or be acifluorfen, acrolein, amitrole, asulam, benazolin, bentazon, bialaphos, bromacil, bromoxynil, chloramben, chloroacetic acid, clopyralid, 4-(2,4-dichlorophenoxy)butanoic acid (2,4-DB), dalapon, dichlorprop, difenzoquat, diquat, endothall, fenac, fenoxaprop, flamprop, flumiclorac, fluoroglycofen, flupropanate, fomesafen, fosamine, imazameth, imazamethabenz, imazamox, imazapic, imazapyr, imazaquin, imazethapyr, ioxynil, 4-chloro-2-methylphenoxyacetic acid (MCPA), 4-(4-chloro-2-methylphenoxy)butanoic acid (MCPB), mecoprop, methylarsonic acid, naptalam, nonanoic acid, paraquat, picloram, quinclorac, sulfamic acid, 2,3,6-trichlorobenzoic acid (2,3,6-TBA), trichloroacetate (TCA), triclopyr, acetochlor, aclonifen, alachlor, ametryn, anilofos, atrazine, azafenidin, benfluralin, benfuresate, bensulide, benzofenap, bifenox, bromobutide, bromofenoxim, butachlor, butamifos, butralin, butroxydim, butylate, cafenstrole, carbetamide, carfentrazone-ethyl, chlomethoxyfen, chlorbromuron, chloridazon, chlornitrofen, chlorotoluron, chlorpropham, chlorthal-dimethyl, chlorthiamid, cinmethylin, clethodim, clodinafop-propargyl, clomazone, clomeprop, cloransulam-methyl, cyanazine, cycloate, cycloxydim, cyhalofop-butyl, daimuron, desmedipham, desmetryn, dichlobenil, diclofop-methyl, diflufenican, dimefuron, dimepiperate, dimethachlor, dimethametryn, dimethenamid, dinitramine, dinoterb, diphenamid, dithiopyr, diuron, ethyl N,N-dipropylcarbamothioate (EPTC), esprocarb, ethalfluralin, ethofumesate, etobenzanid, fenoxaprop-ethyl, fenuron, flamprop-methyl, fluazifop-butyl, fluchloralin, flumetsulam, flumiclorac-pentyl, flumioxazin, fluometuron, fluorochloridone, fluoroglycofen-ethyl, flupoxam, flurenol, fluridone, fluoroxypyr-1-methylheptyl, flurtamone, fluthiacet-methyl, fomesafen, haloxyfop-methyl, hexazinone, imazamox, indanofan, isoproturon, isouron, isoxaben, isoxaflutole, isoxapyrifop, lactofen, lenacil, linuron, mefenacet, mesotrione, metamitron, metazachlor, methabenzthiazuron, methyldymron, metobenzuron, metobromuron, metolachlor, metosulam, metoxuron, metribuzin, molinate, monolinuron, naproanilide, napropamide, naptalam, neburon, norflurazon, orbencarb, oryzalin, oxadiargyl, oxadiazon, oxyfluorfen, pebulate, pendimethalin, pentanochlor, pentoxazone, phenmedipham, piperophos, pretilachlor, prodiamine, prometon, prometryn, propachlor, propanil, propaquizafop, propazine, propham, propisochlor, propyzamide, prosulfocarb, pyraflufen-ethyl, pyrazolynate, pyrazoxyfen, pyributicarb, pyridate, pyriminobac-methyl, quinclorac, quinmerac, quizalofop-ethyl, sethoxydim, siduron, simazine, simetryn, sulcotrione, sulfentrazone, tebutam, tebuthiuron, terbacil, terbumeton, terbuthylazine, terbutryn, thenylchlor, thiazopyr, thiobencarb, tiocarbazil, tralkoxydim, triallate, trietazine, trifluralin, triflusulfuron, vernolate, and salts and combinations thereof.

In other embodiments, the co-herbicide may be or include 4-chlorophenoxyacetic acid (4-CPA) or a salt thereof, 3,4-dichlorophenoxyacetic acid (3,4-DA) or a salt thereof, 4-chloro-2-methylphenoxyacetic acid (MCPA) or a salt thereof, 2,4,5-trichlorophenoxyacetic acid (2,4,5-T) or a salt thereof, 2-(3-chlorophenoxy)propanoic acid (cloprop) or a salt thereof, 2-(4-chlorophenoxy)propanoic acid (4-CPP) or a salt thereof, 2-(2,4-dichlorophenoxy)propanoic acid (dichlorprop) or a salt thereof, 2-(3,4-dichlorophenoxy)propanoic acid (3,4-DP) or a salt thereof, 2-(2,4,5-trichlorophenoxy)propanoic acid (fenoprop) or a salt thereof, 2-(4-chloro-2-methylphenoxy)propanoic acid (mecoprop) or a salt thereof, 4-(4-chlorophenoxy)butanoic acid (4-CPB) or a salt thereof, 4-(2,4-dichlorophenoxy)butanoic acid (2,4-DB) or a salt thereof, 4-(3,4-dichlorophenoxy)butanoic acid (3,4-DB) or a salt thereof, 4-(4-chloro-2-methylphenoxy)butanoic acid (MCPB) or a salt thereof, 4-(2,4,5-trichlorophenoxy)butanoic acid (2,4,5-TB) or a salt thereof, 3-amino-2,5-dichlorobenzoic acid (chloramben) or a salt thereof, 2,3,6-trichlorobenzoic acid (2,3,6-TBA) or a salt thereof, 2,3,5-trichloro-6-methoxybenzoic acid (tricamba) or a salt thereof, 4-amino-3,6-dichloro-2-pyridinecarboxylic acid (aminopyralid) or a salt thereof, 3,6-dichloro-2-pyridinecarboxylic acid (clopyralid) or a salt thereof, 4-amino-3,5,6-trichloro-2-pyridinecarboxylic acid (picloram) or a salt thereof, 3,5,6-trichloro-2-pyridinyl-oxyacetic acid (triclopyr) or a salt thereof, and combinations thereof.

The agrochemical is present in an amount of from about 0.05 to about 60 weight percent based on a total weight of the composition. In various embodiments, the agrochemical is present in an amount of from about 0.05 to about 1, about 0.1 to about 0.95, about 0.15 to about 0.9, about 0.2 to about 0.85, about 0.25 to about 0.8, about 0.3 to about 0.75, about 0.35 to about 0.7, about 0.4 to about 0.65, about 0.45 to about 0.6, or about 0.5 to about 0.55, weight percent based on a total weight of the composition. In other embodiments, the agrochemical is present in an amount of from about 1 to about 60, about 5 to about 55, about 10 to about 50, about 15 to about 45, about 20 to about 40, about 25 to about 35, or about 30 to about 35, weight percent based on a total weight of the composition. In further embodiments, the composition may be an in-can composition such that the agrochemical is present in an amount of from about 15 to about 60, about 20 to about 55, about 25 to about 50, about 30 to about 50, about 35 to about 45, about 40 to about 45, about 30 to about 60, about 35 to about 55, about 40 to about 50, or about 40 to about 55, weight percent based on a total weight of the composition. In other embodiments, the composition may be a spray composition and the agrochemical may be present in an amount of from about 0.05 to about 5, about 0.1 to about 4.9, about 0.2 to about 4.8, about 0.3 to about 4.7, about 0.4 to about 4.6, about 0.5 to about 4.5, about 0.6 to about 4.4, about 0.7 to about 4.3, about 0.8 to about 4.2, about 0.9 to about 4.1, about 1 to about 4, about 1.1 to about 3.9, about 1.2 to about 3.8, about 1.3 to about 3.7, about 1.4 to about 3.6, about 1.5 to about 3.5, about 1.6 to about 3.4, about 1.7 to about 3.3, about 1.8 to about 3.2, about 1.9 to about 3.1, about 2 to about 3, about 2.1 to about 2.9, about 2.2 to about 2.8, about 2.3 to about 2.7, about 2.4 to about 2.6, or about 2.5, weight percent based on a total weight of the composition. In various non-limiting embodiments, all values and ranges thereof, both whole and fractional, including and between those set forth above, are hereby expressly contemplated for use herein.

Referring now to the surfactant, the surfactant is present in an amount of from about 0.05 to about 50 weight percent based on a total weight of the composition. In various embodiments, the surfactant is present in an amount of from about 0.05 to about 1, about 0.1 to about 0.95, about 0.15 to about 0.9, about 0.2 to about 0.85, about 0.25 to about 0.8, about 0.3 to about 0.75, about 0.35 to about 0.7, about 0.4 to about 0.65, about 0.45 to about 0.6, or about 0.5 to about 0.55, weight percent based on a total weight of the composition. In other embodiments, the surfactant is present in an amount of from about 1 to about 50, about 5 to about 45, about 10 to about 40, about 15 to about 35, about 20 to about 30, or about 25 to about 30, weight percent based on a total weight of the composition. In further embodiments, the composition may be an in-can composition such that the surfactant is present in an amount of from about 5 to about 50, about 10 to about 45, about 15 to about 40, about 20 to about 35, or about 25 to about 30, weight percent based on a total weight of the composition. In other embodiments, the composition may be a spray composition and the surfactant may be present in an amount of from about 0.05 to about 0.5, about 0.1 to about 0.45, about 0.15 to about 0.4, about 0.2 to about 0.35, about 0.25 to about 0.3, or about 0.3 to about 0.35, weight percent based on a total weight of the composition. In various non-limiting embodiments, all values and ranges thereof, both whole and fractional, including and between those set forth above, are hereby expressly contemplated for use herein.

The surfactant may be, include, consist essentially of, or consist of:
(i) at least one alkoxylated monoglyceride present in an amount of from about 30 to about 45 weight percent based on a total weight of the surfactant,
(ii) at least one alkoxylated diglyceride present in an amount of from about 40 to about 50 weight percent based on a total weight of the surfactant,
(iii) at least one alkoxylated triglyceride present in an amount of from about 8 to about 10 weight percent based on a total weight of the surfactant, and
(iv) at least one alkoxylated glycerin present in an amount of from about 6 to about 8 weight percent based on a total weight of the surfactant.

The surfactant may alternatively be, include, consist essentially of, or consist of:
(i) the at least one alkoxylated monoglyceride is present in an amount of from about 35 to about 37 weight percent based on a total weight of the surfactant,
(ii) the at least one alkoxylated diglyceride is present in an amount of from about 47 to about 49 weight percent based on a total weight of the surfactant,
(iii) the at least one alkoxylated triglyceride is present in an amount of from about 8.25 to about 8.75 weight percent based on a total weight of the surfactant, and
(iv) the at least one alkoxylated glycerin is present in an amount of from about 7.25 to about 7.75 weight percent based on a total weight of the surfactant.

The language “consist essentially of” may describe embodiments that are free of other surfactants or include other surfactants in amounts of less than about 5, 4, 3, 2, 1, 0.5, or 0.1, weight percent based on a total weight of the surfactant. These other surfactants may be of any type, e.g. non-ionic, cationic, anionic, and/or amphoteric/zwitterionic surfactants, each of which may be any known in the art. These surfactants include those disclosed in Cutcheon's Emulsifier and Detergents, North America Edition, 2006. Non-limiting examples of cationic surfactants are alkoxylated alkylamine and its quaternary derivative, alkoxylated etheramine and its quaternary derivative, alkoxylated alkyl amine oxide, alkoxylated alkyl etheramine oxide, alkyl amidopropyl amine oxide, alkyl trimethyl ammonium chloride, and alkyl (preferably C₆ to C₁₀) dimethylamidopropylamine. Non-limiting examples of anionic surfactants are alkylsulfate, alkylethersulfate, alkylsulfonate, alkylsulfosuccinate, alkoxylated phosphate ester, alkyl alpha olefin sulfonate, alkyl n-methyl taurate, fatty acid isethionate, and alkyl ether carboxylate. Non-limiting examples of nonionic surfactants are sorbitan ester and its alkoxylated derivative, sorbitol ester and its alkoxylated derivative, fatty acid ester, castor oil alkoxylate, alcohol alkoxylate, alkanolamide, alkanolamide alkoxylate, and alkyl polyglycoside. Non-limiting examples of amphoteric surfactants are alkyl betaine, alkyl amidopropyl betaine, alkylamphoacetate, alkylamphodiacetate, alkylamphocarboxylate, alkylamphopropionate, alkylamphodipropionate, alkyl amidoamine carboxylate, alkylamphohydroxypropyl sulfonate, alkyl sultaine, alkyl amidopropyl hydroxyl sultaine, alkyl dihydroxyethyl glycinate, and alkyl aminopropionate. In various non-limiting embodiments, all values and ranges thereof, both whole and fractional, including and between those set forth above, are hereby expressly contemplated for use herein.

In various embodiments, a co-surfactant may be utilized along with the above surfactant. For example, the co-surfactant may be any known in the art e.g. non-ionic, cationic, anionic, and/or amphoteric/zwitterionic surfactants, or any described above. The co-surfactant may be utilized in any amount up to about the same amount as the surfactant itself is utilized, e.g. as described above. For example, the co-surfactant may be utilized in an amount up to about a 1:1 weight ratio with the surfactant.

Referring now to the at least one alkoxylated monoglyceride, it is present in an amount of from about 30 to about 45 weight percent based on a total weight of the surfactant. In various embodiments, the at least one alkoxylated monoglyceride is present in an amount of from about 30.5 to about 44.5, about 31 to about 44, about 31.5 to about 43.5, about 32 to about 42, about 32.5 to about 41.5, about 33 to about 41, about 33.5 to about 40.5, about 34 to about 40, about 34.5 to about 39.5, about 35 to about 39, about 35.5 to about 38.5, about 36 to about 38, about 36.5 to about 37.5, or about 37 to about 37.5, weight percent based on a total weight of the surfactant. In various non-limiting embodiments, all values and ranges thereof, both whole and fractional, including and between those set forth above, are hereby expressly contemplated for use herein.

In various embodiments, the at least one alkoxylated monoglyceride has a structure:

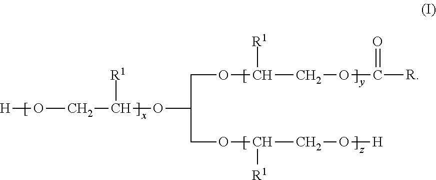

In this structure, each R is independently a C7-C23 saturated or unsaturated group, each R¹ is independently H, CH₃, or CH₂CH₃, and a total of (x+y+z) is from about 2 to about 40.

Referring now to the at least one alkoxylated diglyceride, it is present in an amount of from about 40 to about 50 weight percent based on a total weight of the surfactant. In various embodiments, the at least one alkoxylated diglyceride is present in an amount of from about 40.5 to about 49.5, about 41 to about 49, about 41.5 to about 48.5, about 42 to about 48, about 42.5 to about 47.5, about 43 to about 47, about 43.5 to about 46.5, about 44 to about 46, about 44.5 to about 45.5, or about 45 to about 45.5, weight percent based on a total weight of the surfactant. In various non-limiting embodiments, all values and ranges thereof, both whole and fractional, including and between those set forth above, are hereby expressly contemplated for use herein.

In various embodiments, the at least one alkoxylated diglyceride has a structure:

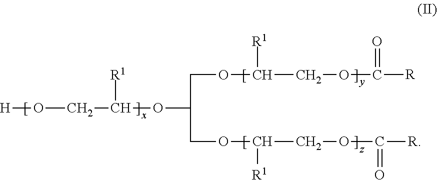

In this structure, each R is independently a C7-C23 saturated or unsaturated group, each R¹ is independently H, CH₃, or CH₂CH₃, and a total of (x+y+z) is from about 2 to about 40.

Referring now to the at least one alkoxylated triglyceride, it is present in an amount of from about 8 to about 10 weight percent based on a total weight of the surfactant. In various embodiments, the at least one alkoxylated triglyceride is present in an amount of from about 8.5 to about 9.5, about 8.5 to about 9, or about 9 to about 9.5, weight percent based on a total weight of the surfactant. In various non-limiting embodiments, all values and ranges thereof, both whole and fractional, including and between those set forth above, are hereby expressly contemplated for use herein.

In various embodiments, the at least one alkoxylated triglyceride has a structure:

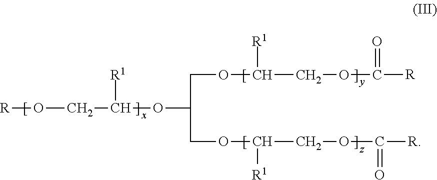

In this structure, each R is independently a C7-C23 saturated or unsaturated group, each R¹ is independently H, CH₃, or CH₂CH₃, and a total of (x+y+z) is from about 2 to about 40.

Referring now to the at least one alkoxylated glycerin, it is present in an amount of from about 6 to about 8 weight percent based on a total weight of the surfactant. In various embodiments, the at least one alkoxylated glycerin is present in an amount of from about 6.5 to about 7.5, about 6.5 to about 7, or about 7 to about 7.5, weight percent based on a total weight of the surfactant. In various non-limiting embodiments, all values and ranges thereof, both whole and fractional, including and between those set forth above, are hereby expressly contemplated for use herein.

In various embodiments, the at least one alkoxylated glycerin has a structure:

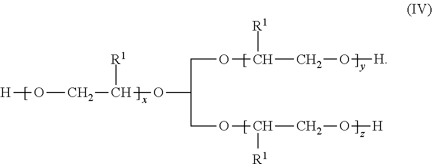

In this structure, each R is independently a C7-C23 saturated or unsaturated group, each R¹ is independently H, CH₃, or CH₂CH₃, and a total of (x+y+z) is from about 2 to about 40.

In each of the structures above, any one or more of R, both within and between structures, may independently be a C7-C23 saturated or unsaturated group, i.e., a group that includes 7, 8, 9, 10, 11, 12, 13, 14, 15, 16, 17, 18, 19, 20, 21, 22, or 23 carbon atoms. In various embodiments, the C7-C23 saturated or unsaturated group may have from 7 to 23, 8 to 22, 9 to 21, 10 to 20, 11 to 19, 12 to 18, 13 to 17, 14 to 16, 8 to 18, 8 to 16, 8 to 14, 8 to 12, 8 to 10, 10 to 18, 10 to 16, 10 to 14, 10 to 12, 12 to 18, 12 to 16, 12 to 14, 14 to 18, 14 to 16, or 16 to 18, carbon atoms. Moreover, the saturated group may be any known in the art including all possible isomers, having the aforementioned number of carbon atoms. Similarly, the unsaturated group may be any known in the art including all possible isomers having the aforementioned number of carbon atoms. For example, one or more R groups may differ within the same structure and/or may differ between structures. In various non-limiting embodiments, all values and ranges thereof, both whole and fractional, including and between those set forth above, are hereby expressly contemplated for use herein.

Furthermore, any one or more of R¹, both within and between structures, may independently be H, CH₃, or CH₂CH₃. For example, one or more R¹ groups may differ within the same structure and/or may differ between structures.

In addition, a total of (x+y+z) in each structure is independently from about 2 to about 40. In various embodiments, this total is from about 3 to about 39, about 4 to about 38, about 5 to about 37, about 6 to about 36, about 7 to about 35, about 8 to about 34, about 9 to about 33, about 10 to about 32, about 11 to about 31, about 12 to about 30, about 13 to about 29, about 14 to about 28, about 15 to about 27, about 16 to about 26, about 17 to about 25, about 18 to about 24, about 19 to about 23, about 20 to about 22, about 21 to about 22, or about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40. For example, the total may be the same or may be different between structures. In various non-limiting embodiments, all values and ranges thereof, both whole and fractional, including and between those set forth above, are hereby expressly contemplated for use herein.

The agrochemical composition may include or be free of one or more of the following: acaricides, bactericides, insecticides, herbicide safeners, insect attractants, insect repellents, plant activators, plant growth regulators, synergists, dyes, stabilizers, fragrants, viscosity-lowering additives, compatibility agents, freeze-point depressants, or combinations thereof.

For example, the composition may include or be free of an insecticide such as those defined by the genera organophosphorus, insect growth regulators (such as chitin synthesis inhibitors, juvenile hormone mimics, and moulting hormones, inhibitors and mimics), pyrethroids, phthalimides, pyrazoles, organochlorines, carbamates and nicotinoids, azinphos-ethyl, beta-cypermethrin, coumaphos, fenoxycarb, pyridaphenthion, pyrimidifen, and tetramethrin, and combinations thereof.

### One or More Additives:

The composition can include or be free of one or more additives. For example, the additives may be ammonium sulfate, potassium sulfate, potassium chloride, sodium sulfate, urea, glycerol, glycols, polyglycols, or mixtures thereof. In other embodiments, the additive may be described as a co-adjuvant, quick-burn additive, humectant, co-herbicide, other pesticides, fungicides, insecticides, plant health agents, other amine compounds, e.g., dimethylamine, isopropylamine, triethylamine, diethanolamine, dye, pigment, corrosion inhibitor, thickener, dispersing agent, calcium sequestrant, foam-moderating or anti-foaming agents, antifreeze, solubility enhancing component, pour-point depressant, anti-gelling agents, pH modifiers, preservatives, hydrotropes, solvents, process aids, or mixtures thereof. In further embodiments, the additive may be an anti-foaming agent such as a silicone-based compositions. An example of a foam-moderating agent for compositions is SAG-10, available from GE Silicones Corporation (Wilton, Conn.).

In further embodiments, the additive may be one or more preservatives such as biocides such mildewstats and bacteriostats, methyl, ethyl and propyl parabens; short chain organic acids (e.g. acetic, lactic and/or glycolic acids); bisguanidine compounds (e.g. Dantagard and/or Glydant); short chain alcohols (e.g. ethanol and/or IPA); 5-chloro-2-methyl-4-isothiazolin-3-one (KATHON GC), 2-methyl-4-isothiazolin-3-one (KATHON ICP), 5-chloro-2-methyl-4-isothiazolin-3-one (KATHON 886), all available from Rohm and Haas Company; 2-bromo-2-nitropropane 1,3 diol (BRONOPOL), from Boots Company Ltd.; propyl-p-hydroxybenzoate (PROXEL CRL), from ICI PLC; 1,2-Benzisothiazol-3(2H)-one biocide (PROXEL GXL) from Zeneca Specialties Co.; o-phenyl-phenol, Na+ salt (NIPASOL M) from Nipa Laboratories Ltd.; 1,2-Benzoisothiazolin-3-one (DOWICIDE A) and 1-(3-chloroallyl)-3,5,7-triaza-1-azoniaadamantane chloride (DOWICIL 75), and DOWICIL 150 containing cis-1-(3-chloroallyl)-3,5,7-triaza-1-azoniaadmatane chloride (CAS No. 051229-78-8) from Dow Chemical Co.; quaternary alkyl ammonium chloride in 2-propanol (ARQUAD 2.8-50) from Akzo Nobel; 2,4,4′-trichloro-2-hydroxydiphenylether (IRGASAN DP 200), from Ciba-Geigy A.G; NIPACIDE BIT20DPG containing benzisothiazolinone available from Clariant Corporation (Greensboro, N.C.), LEGEND MK anti-microbial biocide available from Rohm and Haas Co. (Philadelphia, Pa.), sorbic acid, mixtures thereof and the like.

In additional embodiments, the additive may be a suitable antifreeze agent such as ethylene glycol and propylene glycol. Antifreeze agents assist in lowering the freezing point of aqueous solutions and maintaining solubility of the components of the composition such that components do not crystallize or precipitate during cycles of freezing and thawing.

The additive may also be a solubility-enhancing agent (also commonly referred to as a cloud point enhancer or stabilizer) may significantly improve the properties of the formulations. Solubility-enhancing agents include polymer derivatives of ethylene glycol and propylene glycol (e.g., 200-1200 average molecular weight), glycerol, sugars, mixtures thereof and the like. In other embodiments, the additive may be a suitable dyes such as food-grade dyes, pigment dyes, and caramel.

### Method of Preparing the Agrochemical Composition

The agrochemical composition may be formed by any method known in the art including mixing the components together in any order and in a batch or continuous process. For example, the method may include the steps of providing the agrochemical, providing the surfactant, and providing any optional ingredients and mixing the components together.

The composition may be formed using any method or order of addition known in the art. In various embodiments, the components may be combined using a mechanical stirrer, ball milling, or any other suitable container or device producing the necessary amount of agitation or circulation to thoroughly mix the ingredients. Compositions of the present disclosure ready for use (i.e., RTU compositions) can be prepared by dilution or mixing.

### Method of Preparing the Surfactant:

The surfactant may be prepared by any method known in the art. For example, in various embodiments, the surfactant can be prepared by various glycerolysis methods, e.g. as described in a review article (Norman Sonntag, JAOCS, vol. 59, No. 10 Oct. 1982, Page 795A-802A). In other embodiments, the surfactant is obtained by a trans esterification process which reacts glycerine with triglycerides or fatty acids followed by alkoxylation. The surfactant can also be obtained by alkoxylating glycerine first then followed by esterification with fatty acids or fatty acid esters.

Sonntag describes a variety of glycerolysis methods, including batch-type processes. These methods are described as generally including (a) use of heat and agitation to maximize solubility of glycerol in the fatty phases, (b) use of excess glycerol over the theoretical requirement of 2 moles, and removal of excess glycerol at the end of the glycerolysis, (c) use of a catalyst/emulsifier system, and (d) catalyst neutralization after completion of the reaction and before removal of excess glycerol and cooling.

One consideration described as affecting the practical success of glycerolysis is establishing a sufficient degree of homogeneity, or solubility of the glycerol in the initial triglyceride fat or in subsequent fat-like phases. Glycerol is not soluble in common fats to a degree that allows for the molar excess of glycerol to react to completion at room temperature. Accordingly, elevated temperatures (e.g., temperatures in excess of about 200° C., in excess of about 220° C., or about 240° C.) are typically used to increase the solubility of glycerol and drive the reaction to completion. The upper temperature limit may depend on a variety of factors. For example, undesired by-products (e.g., acrolein) may be formed at temperatures in excess of 255° C., or in excess of 260° C. Agitation may also be utilized to promote solubility of the glycerol. Neither the manner nor degree of agitation are narrowly critical, and may be selected by one skilled in the art in view of the particular reaction conditions.

Glycerolysis reactions are typically catalyzed, often using alkaline catalysts (e.g., NaOH, KOH, Ca(OH)₂, CaO, SrO), the sodium salts of lower aliphatic alcohols (e.g., methanol and ethanol), and acids. Various metals such as Na, K, or Sn may also be utilized as catalysts. Generally, alkaline catalysts are preferred. More particularly, due to their effectiveness and low cost, NaOH and KOH are generally preferred as catalysts for industrial glycerolysis. Since the catalyst increases the reaction rate, the presence of the catalyst may increase reversion of the desired monoglycerides back to reactant form. This reversion may be minimized by relatively rapid neutralization of the catalyst, cooling of the reaction mixture and/or removal of the glycerol at the end of the desired reaction period.

Sonntag also describes and/or lists a variety of batch and continuous glycerolysis methods known in the art including, for example, U.S. Pat. Nos. 4,025,540; 4,950,441; and 6,723,863, the entire contents of which are incorporated by reference herein for all relevant purposes in various non-limiting embodiments. Batch-type glycerolysis methods include those described in U.S. Pat. Nos. 1,505,560; 2,197,339; 2,197,340; 2,206,167; 2,206,168; 2,748,354; 2,496,328; 2,909,540; and 3,083,216, the entire contents of which are incorporated herein by reference for all relevant purposes in various non-limiting embodiments. Continuous glycerolysis methods include those described in U.S. Pat. Nos. 2,383,581; 2,474,740; 2,634,278; 2,634,279; 2,875,221; 3,102,129; 3,095,431; 3,079,412; 3,313,834; and 4,950,441, the entirety of which are hereby expressly incorporated in their entirety in various non-limiting embodiments.

The relative proportions of glycerol and fatty acids may be selected to provide a mixture of glycerides. Regardless of the order of alkoxylation and esterification, alkoxylation to prepare the compounds of this disclosure can be generally conducted in accordance with conventional methods known in the art. Alkoxylation generally includes a condensation reaction between an alkylene oxide and an organic compound containing at least one active hydrogen (i.e., glycerol or an ester thereof) in the presence of a catalyst. A wide variety of catalysts are well-known for use in alkoxylation processes including, for example, various acidic and alkaline catalysts (e.g., potassium hydroxide). Various alkoxylation methods are well-known in the art including, for example, those described in U.S. Pat. Nos. 4,754,075; 5,114,900; and 5,120,697. The conditions of suitable alkoxylation methods are well-known in the art. For example, the temperature of the reaction is typically sufficient to provide a suitable rate of reaction, but without undesired degradation of the reactants or reaction products. Generally, alkoxylation temperatures can range from about 50° C. to about 270° C., or from about 100° C. to about 200° C. The pressure of the alkoxylation reaction is not narrowly critical. Typically, the alkoxylation medium is agitated to promote dispersion of the reactants and catalyst throughout. All of the aforementioned references are hereby expressly incorporated in their entirety in various non-limiting embodiments. In various non-limiting embodiments, all values and ranges thereof, both whole and fractional, including and between those set forth above, are hereby expressly contemplated for use herein.

The present disclosure also provides a method for killing or controlling weeds or other unwanted plants or fungi by spraying or otherwise applying an effective amount of the composition to the target to be treated. The composition can be applied to the foliage of the plants to be treated through any of the appropriate methods that are well known to those having skill in the art. In some embodiments, an RTU composition is packaged in a portable container suitable for hand carry by the user and fitted with an apparatus for manually releasing the composition from the container onto the foliage of the plants to be treated in the form of a spray.

The compositions of the present disclosure can be used to kill or control the growth of a wide variety of plants, fungi, etc. In various embodiments, the plant includes velvetleaf (Abutilon theophrasti), pigweed (Amaranthus spp.), buttonweed (Borreria spp.), oilseed rape, canola, indian mustard, etc. (Brassica spp.), commelina (Commelina spp.), filaree (Erodium spp.), sunflower (Helianthus spp.), morningglory (Ipomoea spp.), kochia (Kochia scoparia), mallow (Malva spp.), wild buckwheat, smartweed, etc. (Polygonum spp.), purslane (Portulaca spp.), Russian thistle (Salsola spp.), sida (Sida spp.), wild mustard (Sinapis arvensis) and cocklebur (Xanthium spp.). In other embodiments, the plant includes wild oat (Avena fatua), carpetgrass (Axonopus spp.), downy brome (Bromus tectorum), crabgrass (Digitaria spp.), barnyardgrass (Echinochloa crus-galli), goosegrass (Eleusine indica), annual ryegrass (Lolium multiflorum), rice (Oryza sativa), ottochloa (Ottochloa nodosa), bahiagrass (Paspalum notatum), canarygrass (Phalaris spp.), foxtail (Setaria spp.), wheat (Triticum aestivum) and corn (Zea mays). In other embodiments, the plant includes mugwort (Artemisia spp.), milkweed (Asclepias spp.), Canada thistle (Cirsium arvense), field bindweed (Convolvulus arvensis) and kudzu (Pueraria spp.). In further embodiments, the plant includes brachiaria (Brachiaria spp.), bermudagrass (Cynodon dactylon), quackgrass (Elymus repens), lalang (Imperata cylindrica), perennial ryegrass (Lolium perenne), guineagrass (Panicum maximum), dallisgrass (Paspalum dilatatum), reed (Phragmites spp.), johnsongrass (Sorghum halepense) and cattail (Typha spp.). In further embodiments, the plant includes horsetail (Equisetum spp.), bracken (Pteridium aquilinum), blackberry (Rubus spp.) and gorse (Ulex europaeus).

Various application methods may be employed including broadcast spraying, directed spraying or wiping the foliage with a diluted composition of this disclosure. Depending on the degree of control desired, the age and species of the plants, weather conditions and other factors, typically the application rate is an effective amount of about 0.1 to about 10 kg a.e./ha and preferably from about 0.25 to about 2.5 kg a.e./ha, although greater or lesser amounts may be applied. In various non-limiting embodiments, all values and ranges thereof, both whole and fractional, including and between those set forth above, are hereby expressly contemplated for use herein.

### Additional Embodiments

In one embodiment, the composition is an in-can composition, wherein the agrochemical is the herbicide;
the herbicide is present in an amount of from about 15 to about 60 weight percent based on a total weight of the composition; and
the surfactant is present in an amount of from about 5 to about 50 weight percent based on a total weight of the composition.

In another embodiment, the composition is a spray composition, wherein the agrochemical is the herbicide;
the herbicide is present in an amount of from about 0.05 to about 5 weight percent based on a total weight of the composition; and
the surfactant is present in an amount of from about 0.05 to about 0.5 weight percent based on a total weight of the composition.

In various non-limiting embodiments, all values and ranges thereof, both whole and fractional, including and between those set forth above, are hereby expressly contemplated for use herein.

In another embodiment, the composition is an in-can composition, wherein the agrochemical is the fungicide;
the herbicide is present in an amount of from about 15 to about 60 weight percent based on a total weight of the composition; and
the surfactant is present in an amount of from about 5 to about 50 weight percent based on a total weight of the composition.

In another embodiment, the composition is a spray composition, wherein the agrochemical is the fungicide;
the herbicide is present in an amount of from about 0.05 to about 5 weight percent based on a total weight of the composition; and
the surfactant is present in an amount of from about 0.05 to about 0.5 weight percent based on a total weight of the composition.

In various non-limiting embodiments, all values and ranges thereof, both whole and fractional, including and between those set forth above, are hereby expressly contemplated for use herein.

In another embodiment, each R¹ is H or CH₃.

In another embodiment:
(i) the at least one alkoxylated monoglyceride is present in an amount of from about 35 to about 43 weight percent based on a total weight of the surfactant,
(ii) the at least one alkoxylated diglyceride is present in an amount of from about 41 to about 48 weight percent based on a total weight of the surfactant,
(iii) the at least one alkoxylated triglyceride is present in an amount of from about 8.5 to about 9 weight percent based on a total weight of the surfactant, and
(iv) the at least one alkoxylated glycerin is present in an amount of from about 7 to about 7.5 weight percent based on a total weight of the surfactant.

In various non-limiting embodiments, all values and ranges thereof, both whole and fractional, including and between those set forth above, are hereby expressly contemplated for use herein.

In another embodiment a mole ratio of mono-glyceride to di-glyceride is about 1.2:1 to about 1.8:1. In various non-limiting embodiments, all values and ranges thereof, both whole and fractional, including and between those set forth above, are hereby expressly contemplated for use herein.

In another embodiment a weight ratio of mono-glyceride to di-glyceride is about 0.74 to about 1.04. In various non-limiting embodiments, all values and ranges thereof, both whole and fractional, including and between those set forth above, are hereby expressly contemplated for use herein.

In another embodiment, the composition is a spray composition, wherein
the agrochemical is the glufosinate present in an amount of from about 0.05 to about 5 weight percent based on a total weight of the composition;
the surfactant is present in an amount of from about 0.05 to about 0.5 weight percent based on a total weight of the composition wherein each R¹ is H or CH₃, and
(i) the at least one alkoxylated monoglyceride is present in an amount of from about 35 to about 43 weight percent based on a total weight of the surfactant,
(ii) the at least one alkoxylated diglyceride is present in an amount of from about 41 to about 48 weight percent based on a total weight of the surfactant,
(iii) the at least one alkoxylated triglyceride is present in an amount of from about 8.5 to about 9 weight percent based on a total weight of the surfactant, and
(iv) the at least one alkoxylated glycerin is present in an amount of from about 7 to about 7.5 weight percent based on a total weight of the surfactant.

In various non-limiting embodiments, all values and ranges thereof, both whole and fractional, including and between those set forth above, are hereby expressly contemplated for use herein.

In another embodiment, the composition is an in-can composition, wherein
the agrochemical is the glufosinate present in an amount of from about 15 to about 60 weight percent based on a total weight of the composition;
the surfactant is present in an amount of from about 5 to about 50 weight percent based on a total weight of the composition wherein each R¹ is H or CH₃, and
(i) the at least one alkoxylated monoglyceride is present in an amount of from about 35 to about 43 weight percent based on a total weight of the surfactant,
(ii) the at least one alkoxylated diglyceride is present in an amount of from about 41 to about 48 weight percent based on a total weight of the surfactant,
(iii) the at least one alkoxylated triglyceride is present in an amount of from about 8.5 to about 9 weight percent based on a total weight of the surfactant, and
(iv) the at least one alkoxylated glycerin is present in an amount of from about 7 to about 7.5 weight percent based on a total weight of the surfactant.

In various non-limiting embodiments, all values and ranges thereof, both whole and fractional, including and between those set forth above, are hereby expressly contemplated for use herein.

In another embodiment, the composition is a spray composition, wherein
the agrochemical is the dicamba present in an amount of from about 0.05 to about 5 weight percent based on a total weight of the composition;
the surfactant is present in an amount of from about 0.05 to about 0.5 weight percent based on a total weight of the composition wherein each R¹ is H or CH₃, and
(i) the at least one alkoxylated monoglyceride is present in an amount of from about 35 to about 43 weight percent based on a total weight of the surfactant,
(ii) the at least one alkoxylated diglyceride is present in an amount of from about 41 to about 48 weight percent based on a total weight of the surfactant,
(iii) the at least one alkoxylated triglyceride is present in an amount of from about 8.5 to about 9 weight percent based on a total weight of the surfactant, and
(iv) the at least one alkoxylated glycerin is present in an amount of from about 7 to about 7.5 weight percent based on a total weight of the surfactant.

In various non-limiting embodiments, all values and ranges thereof, both whole and fractional, including and between those set forth above, are hereby expressly contemplated for use herein.

In another embodiment, the composition is an in-can composition, wherein the agrochemical is the dicamba present in an amount of from about 15 to about 60 weight percent based on a total weight of the composition;
the surfactant is present in an amount of from about 5 to about 50 weight percent based on a total weight of the composition wherein each R¹ is H or CH₃, and
(i) the at least one alkoxylated monoglyceride is present in an amount of from about 35 to about 43 weight percent based on a total weight of the surfactant,
(ii) the at least one alkoxylated diglyceride is present in an amount of from about 41 to about 48 weight percent based on a total weight of the surfactant,
(iii) the at least one alkoxylated triglyceride is present in an amount of from about 8.5 to about 9 weight percent based on a total weight of the surfactant, and
(iv) the at least one alkoxylated glycerin is present in an amount of from about 7 to about 7.5 weight percent based on a total weight of the surfactant.

In various non-limiting embodiments, all values and ranges thereof, both whole and fractional, including and between those set forth above, are hereby expressly contemplated for use herein.

In another embodiment, the composition is a spray composition, wherein
the agrochemical is the 2,4-D present in an amount of from about 0.05 to about 5 weight percent based on a total weight of the composition;
the surfactant is present in an amount of from about 0.05 to about 0.5 weight percent based on a total weight of the composition wherein each R¹ is H or CH₃, and
(i) the at least one alkoxylated monoglyceride is present in an amount of from about 35 to about 43 weight percent based on a total weight of the surfactant,
(ii) the at least one alkoxylated diglyceride is present in an amount of from about 41 to about 48 weight percent based on a total weight of the surfactant,
(iii) the at least one alkoxylated triglyceride is present in an amount of from about 8.5 to about 9 weight percent based on a total weight of the surfactant, and
(iv) the at least one alkoxylated glycerin is present in an amount of from about 7 to about 7.5 weight percent based on a total weight of the surfactant.

In various non-limiting embodiments, all values and ranges thereof, both whole and fractional, including and between those set forth above, are hereby expressly contemplated for use herein.

In another embodiment, the composition is an in-can composition, wherein the agrochemical is the 2,4-D present in an amount of from about 15 to about 60 weight percent based on a total weight of the composition;
the surfactant is present in an amount of from about 5 to about 50 weight percent based on a total weight of the composition wherein each R¹ is H or CH₃, and
(i) the at least one alkoxylated monoglyceride is present in an amount of from about 35 to about 43 weight percent based on a total weight of the surfactant,
(ii) the at least one alkoxylated diglyceride is present in an amount of from about 41 to about 48 weight percent based on a total weight of the surfactant,
(iii) the at least one alkoxylated triglyceride is present in an amount of from about 8.5 to about 9 weight percent based on a total weight of the surfactant, and
(iv) the at least one alkoxylated glycerin is present in an amount of from about 7 to about 7.5 weight percent based on a total weight of the surfactant.

In various non-limiting embodiments, all values and ranges thereof, both whole and fractional, including and between those set forth above, are hereby expressly contemplated for use herein.

In still other embodiments, the weight and mole percents of (i) the at least one alkoxylated monoglyceride, (ii) the at least one alkoxylated diglyceride, (iii) the at least one alkoxylated triglyceride, and (iv) the at least one alkoxylated glycerin, are as set forth below:

| | Mol % | Weight % |
|---|---|---|
| | Ranges | Ranges |
| Zero-ester (glycerol) | | |
| (0, 0, 0) | 20-30 | 4-10 |
| | 22-28 | 6-8 |
| | 24-26 | 7-9 |
| Mono-ester* | | |
| (1, 0, 0) | 28-36 | 26-36 |
| | 30-34 | 28-34 |
| | 32-34 | 30-32 |
| (0, 1, 0) | 1-9 | 1-9 |
| | 3-7 | 3-7 |
| | 4-6 | 4-6 |
| Di-ester (diglycerides)* | | |
| (1, 1, 0) | 6-16 | 12-22 |
| | 8-14 | 14-20 |
| | 10-12 | 16-18 |
| (1, 0, 1) | 16-26 | 26-36 |
| | 18-24 | 28-34 |
| | 20-22 | 30-32 |
| Tri-ester (triglycerides) | | |
| (1, 1, 1) | 1-10 | 4-14 |
| | 2-8 | 6-12 |
| | 4-6 | 8-10 |
| Free acid | n.d. | n.d. |

*Can be sum of both isomers

In various non-limiting embodiments, all values and ranges thereof, both whole and fractional, including and between those set forth above, are hereby expressly contemplated for use herein.

### Examples

### Preparation of Soya Fatty Acid Glycerides

The Esterification of Soya Fatty Acid and Glycerol was conducted using standard methods like the procedures previously outlined by Sonntag. Analysis of the ester mixture, SMG, was done by NMR and is shown in the table below.

### NMR Analysis of Soya Monoglyceride (SMG)

| | Mol % | Weight % |
|---|---|---|
| Zero-ester (glycerol) | | |
| (0, 0, 0) | 24.4 | 7.5 |
| Mono-ester | | |
| (1, 0, 0) | 33.6 | 30.8 |
| (0, 1, 0) | 5.3 | 4.9 |
| Di-ester (diglycerides) | | |
| (1, 1, 0) | 11.2 | 17.0 |
| (1, 0, 1) | 20.6 | 31.3 |
| Tri-ester (triglycerides) | | |
| (1, 1, 1) | 5.0 | 8.5 |
| Free acid | n.d. | n.d. |

### Typical Ethoxylation of Soya Glycerides:

To a 2-L autoclave 300.6 g of SMG and 6 grams of KOH (45%) were added. The system was heated to 110° C. with a nitrogen sparge at 400 cc/min. After drying for 2 hours the KF moisture was 0.04 wt. %. Total samples from the reactor totaled 11.5 grams, leaving 289.1 grams, 0.75 moles of soya-MG. The reactor was then heated to 135° C. and EO (660 g, 15.5 moles) was added over 3 hours, followed by digestion for one hour. The reaction was then cooled to 80° C. and sparged with nitrogen with the vent line open to a scrubber to remove any unreacted EO. 664.8 grams of SMG+20EO was dispensed and 99.4% mass balance was achieved.

Following the same basic procedure other degrees of ethoxylation from 5-50 mol of EO were achieved.

### Additional Examples

### Greenhouse Test 1:

In a first series of Examples, the following compounds are utilized to evaluate the efficacy of various herbicides in combination with various surfactants against two types of weeds:
Herbicides: 2,4-D ester; dicamba; and glufosinate
Surfactants: Glycerol Monosoyate+10EO;
Glycerol Monosoyate+15EO;
Glycerol Monosoyate+20EO;
Glycerol Monosoyate+30EO;
Glycerol Monosoyate+50EO;
Soybean oil+20EO;
Reference 1—Polyoxyethylene (20) sorbitan monolaurate
Reference 2—Sodium lauryl ether sulfate
   The following test protocol is used:

A 2×2 test grid with 2 actives rate and 2 surfactant rates=4 tests on each active/surfactant combination
Active Rate: As set forth in the Tables below
Surfactant Rate:
0.1% & 0.25% for 2,4-D ester
0.1% & 0.25% for dicamba
0.25% & 0.5% for glufosinate
Total #of treatment: 96 (8 surfactant×4 tests on each, each treatment has 4 repetitions)
Weeds: Alfalfa for 2,4-D and dicamba
   Morning glory for glufosinate

Data is collected at end of each week for 4 weeks. The results are shown as % weed control, with standard deviation based on 4 duplicated data points. % weed control is based on visual evaluation of the plant damage (grow slow, grow less, etc.) The treated weed plants do not die after herbicide+surfactant applications. They are just damaged. They can still grow with time. This is why in some data set the % weed control decrease with time as plants re-grow occur.

The results are set forth below in Tables 1A-1D, 2A-2D, and 3A-3D below.
Tables 1A-1D include data associated with 2,4-D.
Tables 2A-2D include data associated with Dicamba.
Tables 3A-3D include data associated with Glufosinate.
   Data Associated with 2,4-D and Tables 1A-1D:

Relative to 2,4-D, Glycerol monosoyate 20EO and 30EO are equal to or better than references.

TABLE 1A

| 2,4-D DMA: | | | | | | | | | | |
|---|---|---|---|---|---|---|---|---|---|---|
| 91 g ae/A | 7 | Stand | 14 | Stand | 21 | Stand | 28 | Stand | | Stand |
| Surfactant: 0.1% | day | Dev. | day | Dev. | day | Dev. | day | Dev. | Avg | Dev. |
| No Surfactant | 0.0 | 0.0 | 0.0 | 0.0 | 27.5 | 15.0 | 32.5 | 15.0 | — | — |
| Glycerol | 65.0 | 5.8 | 83.8 | 2.5 | 65.0 | 5.8 | 72.5 | 9.6 | 13.5 | 3.5 |
| Monosoyate + | | | | | | | | | | |
| 10EO | | | | | | | | | | |
| Glycerol | 65.0 | 5.8 | 81.3 | 8.5 | 71.3 | 13.1 | 71.3 | 13.1 | 12.6 | 10.0 |
| Monosoyate + | | | | | | | | | | |
| 15EO | | | | | | | | | | |
| Glycerol | 60.0 | 0.0 | 75.0 | 5.8 | 62.5 | 9.6 | 67.5 | 9.6 | 16.1 | 1.2 |
| Monosoyate + | | | | | | | | | | |
| 20EO | | | | | | | | | | |
| Glycerol | 67.5 | 5.0 | 77.5 | 8.7 | 70.0 | 8.2 | 67.5 | 5.0 | 15.2 | 3.4 |
| Monosoyate + | | | | | | | | | | |
| 30EO | | | | | | | | | | |
| Glycerol | 62.5 | 5.0 | 80.0 | 7.1 | 67.5 | 15.0 | 65.0 | 10.0 | 12.5 | 3.2 |
| Monosoyate + | | | | | | | | | | |
| 50EO | | | | | | | | | | |
| Soybean oil + | 60.0 | 0.0 | 75.0 | 5.8 | 55.0 | 10.0 | 52.5 | 9.6 | 15.6 | 4.3 |
| 20EO | | | | | | | | | | |
| Polyoxyethylene | 67.5 | 5.0 | 83.8 | 2.5 | 70.0 | 8.2 | 72.5 | 9.6 | 10.7 | 2.4 |
| (20) sorbitan | | | | | | | | | | |
| monolaurate | | | | | | | | | | |
| Sodium lauryl | 67.5 | 5.0 | 83.8 | 2.5 | 73.8 | 7.5 | 75.0 | 10.0 | 12.4 | 4.4 |
| ether sulfate | | | | | | | | | | |

TABLE 1B

| 2,4-D DMA: | | | | | | | | | | |
|---|---|---|---|---|---|---|---|---|---|---|
| 91 g ae/A | 7 | Stand | 14 | Stand | 21 | Stand | 28 | Stand | | Stand |
| Surfactant: 0.25% | day | Dev. | day | Dev. | day | Dev. | day | Dev. | Avg | Dev. |
| No Surfactant | 0.0 | 0.0 | 0.0 | 0.0 | 27.5 | 15.0 | 32.5 | 15.0 | | |
| Glycerol | 65.0 | 5.8 | 77.5 | 5.0 | 55.0 | 5.8 | 52.5 | 12.6 | 19.6 | 7.9 |
| Monosoyate + | | | | | | | | | | |
| 10EO | | | | | | | | | | |
| Glycerol | 67.5 | 5.0 | 76.3 | 7.5 | 57.5 | 9.6 | 55.0 | 10.0 | 12.7 | 3.3 |
| Monosoyate + | | | | | | | | | | |
| 15EO | | | | | | | | | | |
| Glycerol | 65.0 | 5.8 | 80.0 | 7.1 | 68.8 | 11.8 | 70.0 | 14.1 | 10.7 | 3.0 |
| Monosoyate + | | | | | | | | | | |
| 20EO | | | | | | | | | | |
| Glycerol | 70.0 | 0.0 | 80.0 | 7.1 | 62.5 | 9.6 | 62.5 | 15.0 | 12.7 | 3.1 |
| Monosoyate + | | | | | | | | | | |
| 30EO | | | | | | | | | | |
| Glycerol | 70.0 | 0.0 | 82.5 | 2.9 | 72.5 | 5.0 | 67.5 | 15.0 | 10.1 | 4.0 |
| Monosoyate + | | | | | | | | | | |
| 50EO | | | | | | | | | | |
| Soybean oil + | 67.5 | 5.0 | 72.5 | 9.6 | 65.0 | 10.0 | 60.0 | 11.5 | 15.7 | 6.3 |
| 20EO | | | | | | | | | | |
| Polyoxyethylene | 67.5 | 5.0 | 81.3 | 2.5 | 67.5 | 5.0 | 72.5 | 5.0 | 9.0 | 1.7 |
| (20) sorbitan | | | | | | | | | | |
| monolaurate | | | | | | | | | | |
| Sodium lauryl | 67.5 | 5.0 | 82.5 | 2.9 | 72.5 | 5.0 | 67.5 | 5.0 | 10.6 | 2.5 |
| ether sulfate | | | | | | | | | | |

TABLE 1C

| 2,4-D DMA: | | | | | | | | | | |
|---|---|---|---|---|---|---|---|---|---|---|
| 91 g ae/A | 7 | Stand | 14 | Stand | 21 | Stand | 28 | Stand | | Stand |
| Surfactant: 0.25% | day | Dev. | day | Dev. | day | Dev. | day | Dev. | Avg | Dev. |
| No Surfactant | 0.0 | 0.0 | 7.5 | 9.6 | 57.5 | 5.0 | 57.5 | 5.0 | | |
| Glycerol | 70.0 | 0.0 | 85.0 | 0.0 | 81.3 | 2.5 | 81.3 | 2.5 | 7.4 | 1.1 |
| Monosoyate + | | | | | | | | | | |
| 10EO | | | | | | | | | | |
| Glycerol | 72.5 | 5.0 | 83.8 | 2.5 | 75.0 | 5.8 | 83.8 | 4.8 | 9.4 | 2.4 |
| Monosoyate + | | | | | | | | | | |
| 15EO | | | | | | | | | | |
| Glycerol | 72.5 | 5.0 | 87.5 | 2.9 | 83.8 | 4.8 | 90.0 | 4.1 | 7.1 | 3.3 |
| Monosoyate + | | | | | | | | | | |
| 20EO | | | | | | | | | | |
| Glycerol | 75.0 | 5.8 | 85.0 | 0.0 | 78.8 | 6.3 | 90.0 | 4.1 | 8.2 | 2.6 |
| Monosoyate + | | | | | | | | | | |
| 30EO | | | | | | | | | | |
| Glycerol | 70.0 | 8.2 | 85.0 | 4.1 | 78.8 | 6.3 | 82.5 | 8.7 | 8.4 | 4.0 |
| Monosoyate + | | | | | | | | | | |
| 50EO | | | | | | | | | | |
| Soybean oil + | 70.0 | 8.2 | 85.0 | 4.1 | 77.5 | 5.0 | 80.0 | 7.1 | 9.9 | 3.3 |
| 20EO | | | | | | | | | | |
| Polyoxyethylene | 72.5 | 5.0 | 86.3 | 2.5 | 80.0 | 0.0 | 85.0 | 4.1 | 7.4 | 1.6 |
| (20) sorbitan | | | | | | | | | | |
| monolaurate | | | | | | | | | | |
| Sodium lauryl | 72.5 | 5.0 | 86.3 | 2.5 | 86.3 | 7.5 | 87.5 | 2.9 | 7.7 | 4.9 |
| ether sulfate | | | | | | | | | | |

TABLE 1D

| 2,4-D DMA: | | | | | | | | | | |
|---|---|---|---|---|---|---|---|---|---|---|
| 91 g ae/A | 7 | Stand | 14 | Stand | 21 | Stand | 28 | Stand | | Stand |
| Surfactant: 0.25% | day | Dev. | day | Dev. | day | Dev. | day | Dev. | Avg | Dev. |
| No Surfactant | 0.0 | 0.0 | 7.5 | 9.6 | 57.5 | 5.0 | 57.5 | 5.0 | | |
| Glycerol | 70.0 | 0.0 | 82.5 | 2.9 | 77.5 | 5.0 | 81.3 | 7.5 | 11.8 | 1.7 |
| Monosoyate + | | | | | | | | | | |
| 10EO | | | | | | | | | | |
| Glycerol | 70.0 | 0.0 | 83.8 | 2.5 | 77.5 | 5.0 | 80.0 | 7.1 | 11.4 | 1.8 |
| Monosoyate + | | | | | | | | | | |
| 15EO | | | | | | | | | | |
| Glycerol | 72.5 | 5.0 | 82.5 | 2.9 | 77.5 | 5.0 | 83.8 | 2.5 | 12.3 | 0.7 |
| Monosoyate + | | | | | | | | | | |
| 20EO | | | | | | | | | | |
| Glycerol | 70.0 | 8.2 | 83.8 | 2.5 | 78.8 | 6.3 | 82.5 | 9.6 | 11.0 | 5.9 |
| Monosoyate + | | | | | | | | | | |
| 30EO | | | | | | | | | | |
| Glycerol | 70.0 | 0.0 | 80.0 | 7.1 | 70.0 | 11.5 | 72.5 | 16.6 | 13.4 | 5.6 |
| Monosoyate + | | | | | | | | | | |
| 50EO | | | | | | | | | | |
| Soybean oil + | 70.0 | 0.0 | 83.8 | 2.5 | 72.5 | 5.0 | 72.5 | 15.0 | 13.5 | 4.0 |
| 20EO | | | | | | | | | | |
| Polyoxyethylene | 72.5 | 5.0 | 82.5 | 2.9 | 76.3 | 7.5 | 81.3 | 2.5 | 9.8 | 3.0 |
| (20) sorbitan | | | | | | | | | | |
| monolaurate | | | | | | | | | | |
| Sodium lauryl | 75.0 | 5.8 | 85.0 | 0.0 | 82.5 | 2.9 | 83.8 | 2.5 | 5.8 | 1.3 |
| ether sulfate | | | | | | | | | | |

Data Associated with Dicamba and Tables 2A-2D:

Relative to Dicamba, Glycerol Monosoyate 15, 20, 30 and 50EO exhibit similar performance to Sodium lauryl ether sulfate, and better performance than Polyoxyethylene (20) sorbitan monolaurate at low active rate. At high active rate, all surfactant exhibit similar performance.

TABLE 2A

| Dicamba: | | | | | | | | | | |
|---|---|---|---|---|---|---|---|---|---|---|
| 23 g ae/A | 7 | Stand | 14 | Stand | 21 | Stand | 28 | Stand | | Stand |
| Surfactant: 0.1% | day | Dev. | day | Dev. | day | Dev. | day | Dev. | Avg | Dev. |
| No Surfactant | 0.0 | 0.0 | 20.0 | 14.1 | 20.0 | 0.0 | 12.5 | 9.6 | | |
| Glycerol | 70.0 | 8.2 | 82.5 | 2.9 | 55.0 | 5.8 | 62.5 | 5.0 | 10.5 | 2.8 |
| Monosoyate + | | | | | | | | | | |
| 10EO | | | | | | | | | | |
| Glycerol | 72.5 | 9.6 | 83.8 | 2.5 | 65.0 | 17.3 | 70.0 | 14.1 | 10.8 | 2.7 |
| Monosoyate + | | | | | | | | | | |
| 15EO | | | | | | | | | | |
| Glycerol | 70.0 | 8.2 | 80.0 | 7.1 | 65.0 | 10.0 | 70.0 | 8.2 | 10.3 | 0.7 |
| Monosoyate + | | | | | | | | | | |
| 20EO | | | | | | | | | | |
| Glycerol | 67.5 | 5.0 | 80.0 | 7.1 | 65.0 | 12.9 | 72.5 | 9.6 | 11.4 | 2.7 |
| Monosoyate + | | | | | | | | | | |
| 30EO | | | | | | | | | | |
| Glycerol | 67.5 | 5.0 | 81.3 | 2.5 | 65.0 | 12.9 | 77.5 | 5.0 | 9.9 | 3.9 |
| Monosoyate + | | | | | | | | | | |
| 50EO | | | | | | | | | | |
| Soybean oil + | 62.5 | 5.0 | 85.0 | 4.1 | 60.0 | 8.2 | 67.5 | 5.0 | 10.0 | 1.3 |
| 20EO | | | | | | | | | | |
| Polyoxyethylene | 62.5 | 5.0 | 73.8 | 7.5 | 50.0 | 11.5 | 62.5 | 5.0 | 11.1 | 1.4 |
| (20) sorbitan | | | | | | | | | | |
| monolaurate | | | | | | | | | | |
| Sodium lauryl | 72.5 | 5.0 | 81.3 | 8.5 | 71.3 | 10.3 | 70.0 | 18.3 | 10.6 | 4.9 |
| ether sulfate | | | | | | | | | | |

TABLE 2B

| Dicamba: | | | | | | | | | | |
|---|---|---|---|---|---|---|---|---|---|---|
| 23 g ae/A | 7 | Stand | 14 | Stand | 21 | Stand | 28 | Stand | | Stand |
| Surfactant: 0.25% | day | Dev. | day | Dev. | day | Dev. | day | Dev. | Avg | Dev. |
| No Surfactant | 0.0 | 0.0 | 20.0 | 14.1 | 20.0 | 0.0 | 12.5 | 9.6 | | |
| Glycerol | 57.5 | 5.0 | 52.5 | 22.2 | 45.0 | 20.8 | 42.5 | 17.1 | 12.2 | 1.9 |
| Monosoyate + | | | | | | | | | | |
| 10EO | | | | | | | | | | |
| Glycerol | 67.5 | 5.0 | 77.5 | 9.6 | 63.8 | 14.9 | 70.0 | 8.2 | 10.6 | 2.7 |
| Monosoyate + | | | | | | | | | | |
| 15EO | | | | | | | | | | |
| Glycerol | 67.5 | 5.0 | 81.3 | 2.5 | 68.8 | 11.8 | 70.0 | 14.1 | 9.9 | 3.7 |
| Monosoyate + | | | | | | | | | | |
| 20EO | | | | | | | | | | |
| Glycerol | 67.5 | 5.0 | 78.8 | 6.3 | 70.0 | 0.0 | 67.5 | 9.6 | 9.1 | 1.2 |
| Monosoyate + | | | | | | | | | | |
| 30EO | | | | | | | | | | |
| Glycerol | 65.0 | 5.8 | 80.0 | 7.1 | 52.5 | 23.6 | 67.5 | 5.0 | 9.9 | 1.7 |
| Monosoyate + | | | | | | | | | | |
| 50EO | | | | | | | | | | |
| Soybean oil + | 65.0 | 5.8 | 73.8 | 7.5 | 57.5 | 5.0 | 65.0 | 5.8 | 10.5 | 2.2 |
| 20EO | | | | | | | | | | |
| Polyoxyethylene | 60.0 | 0.0 | 70.0 | 0.0 | 50.0 | 8.2 | 50.0 | 8.2 | 12.3 | 2.4 |
| (20) sorbitan | | | | | | | | | | |
| monolaurate | | | | | | | | | | |
| Sodium lauryl | 65.0 | 5.8 | 80.0 | 0.0 | 67.5 | 12.6 | 70.0 | 8.2 | 7.9 | 1.5 |
| ether sulfate | | | | | | | | | | |

TABLE 2C

| Dicamba: | | | | | | | | | | |
|---|---|---|---|---|---|---|---|---|---|---|
| 45 g ae/A | 7 | Stand | 14 | Stand | 21 | Stand | 28 | Stand | | Stand |
| Surfactant: 0.1% | day | Dev. | day | Dev. | day | Dev. | day | Dev. | Avg | Dev. |
| No Surfactant | 0.0 | 0.0 | 50.0 | 8.2 | 75.0 | 5.8 | 55.0 | 10.0 | | |
| Glycerol | 75.0 | 10.0 | 86.3 | 2.5 | 77.5 | 8.7 | 80.0 | 7.1 | 8.6 | 2.6 |
| Monosoyate + | | | | | | | | | | |
| 10EO | | | | | | | | | | |
| Glycerol | 67.5 | 5.0 | 80.0 | 0.0 | 70.0 | 0.0 | 73.8 | 7.5 | 10.8 | 1.5 |
| Monosoyate + | | | | | | | | | | |
| 15EO | | | | | | | | | | |
| Glycerol | 75.0 | 10.0 | 85.0 | 4.1 | 77.5 | 5.0 | 80.0 | 8.2 | 9.2 | 3.3 |
| Monosoyate + | | | | | | | | | | |
| 20EO | | | | | | | | | | |
| Glycerol | 72.5 | 5.0 | 76.3 | 7.5 | 70.0 | 0.0 | 73.8 | 11.1 | 10.4 | 3.1 |
| Monosoyate + | | | | | | | | | | |
| 30EO | | | | | | | | | | |
| Glycerol | 67.5 | 9.6 | 82.5 | 2.9 | 71.3 | 13.1 | 75.0 | 5.8 | 7.8 | 1.4 |
| Monosoyate + | | | | | | | | | | |
| 50EO | | | | | | | | | | |
| Soybean oil + | 72.5 | 5.0 | 80.0 | 8.2 | 72.5 | 9.6 | 72.5 | 5.0 | 8.0 | 0.8 |
| 20EO | | | | | | | | | | |
| Polyoxyethylene | 77.5 | 5.0 | 87.5 | 2.9 | 76.3 | 11.1 | 81.3 | 2.5 | 6.4 | 0.4 |
| (20) sorbitan | | | | | | | | | | |
| monolaurate | | | | | | | | | | |
| Sodium lauryl | 72.5 | 9.6 | 82.5 | 2.9 | 76.3 | 11.1 | 76.3 | 7.5 | 7.5 | 1.4 |
| ether sulfate | | | | | | | | | | |

TABLE 2D

| Dicamba: | | | | | | | | | | |
|---|---|---|---|---|---|---|---|---|---|---|
| 45 g ae/A | 7 | Stand | 14 | Stand | 21 | Stand | 28 | Stand | | Stand |
| Surfactant: 0.25% | day | Dev. | day | Dev. | day | Dev. | day | Dev. | Avg | Dev. |
| No Surfactant | 0.0 | 0.0 | 50.0 | 8.2 | 75.0 | 5.8 | 55.0 | 10.0 | | |
| Glycerol | 67.5 | 5.0 | 80.0 | 0.0 | 70.0 | 0.0 | 67.5 | 5.0 | 8.5 | 1.2 |
| Monosoyate + | | | | | | | | | | |
| 10EO | | | | | | | | | | |
| Glycerol | 67.5 | 5.0 | 82.5 | 2.9 | 67.5 | 5.0 | 76.3 | 7.5 | 8.0 | 1.2 |
| Monosoyate + | | | | | | | | | | |
| 15EO | | | | | | | | | | |
| Glycerol | 65.0 | 5.8 | 81.3 | 2.5 | 70.0 | 0.0 | 67.5 | 5.0 | 12.4 | 3.2 |
| Monosoyate + | | | | | | | | | | |
| 20EO | | | | | | | | | | |
| Glycerol | 72.5 | 5.0 | 83.8 | 2.5 | 73.8 | 11.1 | 73.8 | 11.1 | 10.0 | 3.0 |
| Monosoyate + | | | | | | | | | | |
| 30EO | | | | | | | | | | |
| Glycerol | 67.5 | 5.0 | 82.5 | 2.9 | 70.0 | 8.2 | 70.0 | 0.0 | 11.9 | 3.7 |
| Monosoyate + | | | | | | | | | | |
| 50EO | | | | | | | | | | |
| Soybean oil + | 72.5 | 5.0 | 86.3 | 2.5 | 75.0 | 5.8 | 80.0 | 7.1 | 7.8 | 2.8 |
| 20EO | | | | | | | | | | |
| Polyoxyethylene | 70.0 | 0.0 | 83.8 | 2.5 | 75.0 | 5.8 | 78.8 | 6.3 | 7.6 | 1.2 |
| (20) sorbitan | | | | | | | | | | |
| monolaurate | | | | | | | | | | |
| Sodium lauryl | 67.5 | 5.0 | 82.5 | 8.7 | 75.0 | 5.8 | 75.0 | 10.0 | 8.4 | 2.0 |
| ether sulfate | | | | | | | | | | |

Data Associated with Glufosinate and Tables 3A-3D:

Relative to Glufosinate, at low active rate the GMS 15 and 20EO exhibit better performance than ether sulfate. At high active rates, the GMS 15, 20EO and 30EO exhibit similar performance to sodium lauryl ether sulfate.

TABLE 3A

| Glufosinate: 3 oz/a | 7 | Stand | 14 | Stand | 21 | Stand | 28 | Stand | | Stand |
|---|---|---|---|---|---|---|---|---|---|---|
| Surfactant: 0.25% | day | Dev. | day | Dev. | day | Dev. | day | Dev. | Avg | Dev. |
| No Surfactant | 0.0 | 0.0 | 40.0 | 16.3 | 25.0 | 10.0 | 12.5 | 9.6 | | |
| Glycerol | 82.5 | 8.7 | 81.3 | 8.5 | 73.8 | 11.1 | 67.5 | 18.9 | 45.7 | 19.0 |
| Monosoyate + | | | | | | | | | | |
| 10EO | | | | | | | | | | |
| Glycerol | 90.0 | 7.1 | 93.8 | 2.5 | 92.0 | 5.7 | 88.8 | 7.5 | 16.0 | 13.2 |
| Monosoyate + | | | | | | | | | | |
| 15EO | | | | | | | | | | |
| Glycerol | 86.3 | 4.8 | 90.0 | 4.1 | 82.5 | 10.4 | 80.0 | 14.7 | 32.5 | 22.7 |
| Monosoyate + | | | | | | | | | | |
| 20EO | | | | | | | | | | |
| Glycerol | 83.8 | 9.5 | 88.8 | 7.5 | 71.3 | 19.3 | 76.3 | 12.5 | 36.9 | 23.3 |
| Monosoyate + | | | | | | | | | | |
| 30EO | | | | | | | | | | |
| Glycerol | 80.0 | 14.1 | 73.8 | 7.5 | 62.5 | 12.6 | 57.5 | 15.0 | 56.7 | 11.7 |
| Monosoyate + | | | | | | | | | | |
| 50EO | | | | | | | | | | |
| Soybean oil + | 90.0 | 0.0 | 87.5 | 6.5 | 75.0 | 12.2 | 65.0 | 19.1 | 42.4 | 20.5 |
| 20EO | | | | | | | | | | |
| Polyoxyethylene | 85.0 | 0.0 | 80.0 | 8.2 | 58.8 | 19.3 | 56.3 | 19.7 | 60.2 | 18.9 |
| (20) sorbitan | | | | | | | | | | |
| monolaurate | | | | | | | | | | |
| Sodium lauryl | 85.0 | 0.0 | 75.0 | 5.8 | 55.0 | 12.9 | 55.0 | 26.5 | 56.4 | 10.0 |
| ether sulfate | | | | | | | | | | |

TABLE 3B

| Glufosinate: 3 oz/a | 7 | Stand | 14 | Stand | 21 | Stand | 28 | Stand | | Stand |
|---|---|---|---|---|---|---|---|---|---|---|
| Surfactant: 0.5% | day | Dev. | day | Dev. | day | Dev. | day | Dev. | Avg | Dev. |
| No Surfactant | 0.0 | 0.0 | 40.0 | 16.3 | 25.0 | 10.0 | 12.5 | 9.6 | | |
| Glycerol | 88.8 | 2.5 | 88.8 | 4.8 | 80.0 | 8.2 | 75.0 | 12.9 | 36.7 | 16.9 |
| Monosoyate + | | | | | | | | | | |
| 10EO | | | | | | | | | | |
| Glycerol | 88.8 | 2.5 | 86.3 | 4.8 | 66.3 | 20.6 | 67.5 | 5.0 | 43.4 | 9.6 |
| Monosoyate + | | | | | | | | | | |
| 15EO | | | | | | | | | | |
| Glycerol | 93.8 | 2.5 | 95.3 | 3.8 | 94.0 | 4.6 | 89.5 | 11.0 | 7.8 | 8.2 |
| Monosoyate + | | | | | | | | | | |
| 20EO | | | | | | | | | | |
| Glycerol | 90.8 | 5.4 | 86.3 | 7.5 | 81.3 | 10.3 | 67.5 | 12.6 | 39.9 | 21.9 |
| Monosoyate + | | | | | | | | | | |
| 30EO | | | | | | | | | | |
| Glycerol | 90.8 | 5.4 | 89.0 | 13.2 | 87.0 | 12.6 | 85.8 | 11.8 | 19.8 | 24.8 |
| Monosoyate + | | | | | | | | | | |
| 50EO | | | | | | | | | | |
| Soybean oil + | 87.5 | 2.9 | 83.8 | 9.5 | 66.3 | 12.5 | 60.0 | 16.3 | 53.9 | 16.9 |
| 20EO | | | | | | | | | | |
| Polyoxyethylene | 91.3 | 4.8 | 92.0 | 5.7 | 85.0 | 10.8 | 82.5 | 10.4 | 22.5 | 16.0 |
| (20) sorbitan | | | | | | | | | | |
| monolaurate | | | | | | | | | | |
| Sodium lauryl | 87.5 | 5.0 | 90.0 | 4.1 | 87.5 | 6.5 | 77.5 | 18.5 | 31.5 | 20.7 |
| ether sulfate | | | | | | | | | | |

TABLE 3C

| Glufosinate: 6 oz/a | 7 | Stand | 14 | Stand | 21 | Stand | 28 | Stand | | Stand |
|---|---|---|---|---|---|---|---|---|---|---|
| Surfactant: 0.25% | day | Dev. | day | Dev. | day | Dev. | day | Dev. | Avg | Dev. |
| No Surfactant | 0.0 | 0.0 | 55.0 | 19.1 | 40.0 | 14.1 | 27.5 | 15.0 | | |
| Glycerol | 85.0 | 0.0 | 87.5 | 8.7 | 81.3 | 14.9 | 73.8 | 23.6 | 36.6 | 23.2 |
| Monosoyate + | | | | | | | | | | |
| 10EO | | | | | | | | | | |
| Glycerol | 87.5 | 5.0 | 92.0 | 5.7 | 85.8 | 11.8 | 84.5 | 11.4 | 29.3 | 20.0 |
| Monosoyate + | | | | | | | | | | |
| 15EO | | | | | | | | | | |
| Glycerol | 88.8 | 2.5 | 83.8 | 4.8 | 75.0 | 12.9 | 72.5 | 15.0 | 42.2 | 18.4 |
| Monosoyate + | | | | | | | | | | |
| 20EO | | | | | | | | | | |
| Glycerol | 92.5 | 2.9 | 91.3 | 7.5 | 86.3 | 11.1 | 83.8 | 10.3 | 23.8 | 20.8 |
| Monosoyate + | | | | | | | | | | |
| 30EO | | | | | | | | | | |
| Glycerol | 88.8 | 2.5 | 90.0 | 5.8 | 81.3 | 8.5 | 78.8 | 11.8 | 35.4 | 19.0 |
| Monosoyate + | | | | | | | | | | |
| 50EO | | | | | | | | | | |
| Soybean oil + | 90.0 | 4.1 | 91.3 | 4.8 | 83.8 | 11.1 | 81.3 | 13.1 | 33.1 | 21.6 |
| 20EO | | | | | | | | | | |
| Polyoxyethylene | 91.3 | 4.8 | 91.3 | 7.5 | 82.5 | 8.7 | 81.3 | 10.3 | 35.8 | 17.4 |
| (20) sorbitan | | | | | | | | | | |
| monolaurate | | | | | | | | | | |
| Sodium lauryl | 92.5 | 2.9 | 95.8 | 1.5 | 95.8 | 1.5 | 96.5 | 1.7 | 7.5 | 6.0 |
| ether sulfate | | | | | | | | | | |

TABLE 3D

| Glufosinate: 6 oz/a | 7 | Stand | 14 | Stand | 21 | Stand | 28 | Stand | | Stand |
|---|---|---|---|---|---|---|---|---|---|---|
| Surfactant: 0.50% | day | Dev. | day | Dev. | day | Dev. | day | Dev. | Avg | Dev. |
| No Surfactant | 0.0 | 0.0 | 55.0 | 19.1 | 40.0 | 14.1 | 27.5 | 15.0 | | |
| Glycerol | 93.8 | 2.5 | 94.5 | 3.3 | 90.8 | 7.9 | 92.8 | 6.4 | 18.5 | 19.4 |
| Monosoyate + | | | | | | | | | | |
| 10EO | | | | | | | | | | |
| Glycerol | 91.3 | 2.5 | 91.3 | 4.8 | 85.0 | 7.1 | 81.3 | 10.3 | 33.2 | 18.8 |
| Monosoyate + | | | | | | | | | | |
| 15EO | | | | | | | | | | |
| Glycerol | 95.8 | 1.5 | 98.3 | 0.5 | 98.0 | 0.0 | 98.0 | 0.0 | 2.3 | 1.0 |
| Monosoyate + | | | | | | | | | | |
| 20EO | | | | | | | | | | |
| Glycerol | 94.5 | 3.3 | 97.3 | 1.5 | 96.5 | 1.7 | 98.3 | 0.5 | 3.9 | 2.3 |
| Monosoyate + | | | | | | | | | | |
| 30EO | | | | | | | | | | |
| Glycerol | 91.3 | 2.5 | 95.8 | 1.5 | 95.8 | 1.5 | 97.3 | 1.5 | 4.8 | 3.6 |
| Monosoyate + | | | | | | | | | | |
| 50EO | | | | | | | | | | |
| Soybean oil + | 92.5 | 2.9 | 92.0 | 5.7 | 89.5 | 8.4 | 90.3 | 9.2 | 21.0 | 23.1 |
| 20EO | | | | | | | | | | |
| Polyoxyethylene | 91.3 | 2.5 | 93.8 | 2.5 | 94.5 | 3.3 | 95.8 | 1.5 | 10.2 | 5.6 |
| (20) sorbitan | | | | | | | | | | |
| monolaurate | | | | | | | | | | |
| Sodium lauryl | 90.0 | 5.8 | 88.8 | 4.8 | 91.3 | 7.5 | 89.5 | 13.1 | 23.0 | 25.4 |
| ether sulfate | | | | | | | | | | |

### Greenhouse Test 2:

In a second series of Examples, the following compounds are utilized to evaluate the efficacy of various fungicides in combination with various surfactants against fungi:
Fungicides: Hexaconazole 5% EC; Dimethomorph 50WP; Thiophenate methyl 70% WP; Azoxystrobin 23 SC
Surfactants:
   Dioctyl sulfosuccinate
   Alkoxylated glyceride with 20EO;
   Alkoxylated glyceride with 50EO;
   Siloxane Polyalkyleneoxide Copolymer
Fungi:
   Powdery mildew (Erysiphenecator);
   Downy mildew (Plasmopara viticola);
   Anthracnose (Colletotrichum gloeosporioides); and
   Early blight (Alternariasolani).
      The following test protocol is used:

There are 4 different fungicide formulations tested against 4 different pests (fungi). For each test there are untreated control (#1) and fungicide only w/o surfactant (#2). The same general protocol described above was used.

The results are set forth below and show that dioctyl sulfosuccinate shows overall good control in all cases. Only in Table C, does it show a lack of efficacy as compared to the alkoxylated glyceride with 20EO.

Alkoxylated glyceride #1 is a 20EO product.

Alkoxylated glyceride #2 is a 50EO product.

TABLE A
Bio-efficacy of different surfactants with standard fungicide
Hexaconazole 5% EC against powdery mildew on leaves of grapes

| | | | PDI* of | |
|---|---|---|---|---|
| | | Dose | Powdery Mildew | |
| Sr. | | Formulation | On Leaves Of Grapes | |
| No. | Treatments | (ml/g) | Test 1 | Test 2 |
| 1 | Untreated control | — | 22.44 | 31.06 |
| 2 | Hexaconazole 5% EC | 1.00 | 15.56 | 22.31 |
| 3 | Hexaconazole 5% EC + | 1.00 + 1 | 4.88 | 10.00 |
| | Dioctyl sulfosuccinate | | | |
| 4 | Hexaconazole 5% EC + | 1.00 + 1 | 8.38 | 14.75 |
| | alkoxylated glyceride #1 | | | |
| 5 | Hexaconazole 5% EC + | 1.00 + 1 | 12.81 | 18.19 |
| | alkoxylated glyceride #2 | | | |
| 6 | Hexaconazole 5% EC + | 1.00 + 1 | 14.13 | 20.88 |
| | Siloxane Polyalkyleneoxide | | | |
| | Copolymer | | | |

*PDI: Percent Disease Index

TABLE B
Bio-efficacy of different surfactants with standard fungicide
Dimethomorph 50WP against downy mildew on leaves of grapes

| | | | PDI* of | |
|---|---|---|---|---|
| | | Dose | Downy Mildew | |
| Sr. | | Formulation | On Leaves Of Grapes | |
| No. | Treatments | (ml/g) | Test 1 | Test 2 |
| 1 | Untreated control | — | 17.38 | 22.25 |
| 2 | Dimethomorph 50WP | 1.00 | 9.81 | 14.00 |
| 3 | Dimethomorph 50WP + | 1.00 + 1 | 2.56 | 4.38 |
| | Dioctyl sulfosuccinate | | | |
| 4 | Dimethomorph 50WP + | 1.00 + 1 | 5.56 | 8.00 |
| | alkoxylated glyceride #1 | | | |
| 5 | Dimethomorph 50WP + | 1.00 + 1 | 8.13 | 10.88 |
| | alkoxylated glyceride #2 | | | |
| 6 | Dimethomorph 50WP + | | | |
| | Siloxane Polyalkyleneoxide | 1.00 + 1 | 9.06 | 12.94 |
| | Copolymer | | | |

*PDI: Percent Disease Index

TABLE C
Bio-efficacy of different surfactants with standard fungicide
Thiophenate methyl 70% WP against anthracnose of grapes

| | | | PDI* of | |
|---|---|---|---|---|
| | | Dose | Anthracnose | |
| Sr. | | Formulation | On Leaves Of Grapes | |
| No. | Treatments | (ml/g) | Test 1 | Test 2 |
| 1 | Untreated control | — | 12.94 | 17.81 |
| 2 | Thiophenate methyl 70% | 0.71 | 8.75 | 13.25 |
| | WP | | | |
| 3 | Thiophenate methyl 70% | 0.71 + 1 | 1.44 | 3.50 |
| | WP + Dioctyl | | | |
| | sulfosuccinate | | | |
| 4 | Thiophenate methyl 70% | 0.71 + 1 | 1.00 | 2.13 |
| | WP + alkoxylated | | | |
| | glyceride #1 | | | |
| 5 | Thiophenate methyl 70% | 0.71 + 1 | 2.00 | 4.06 |
| | WP + alkoxylated | | | |
| | glyceride #2 | | | |
| 6 | Thiophenate methyl 70% | 0.71 + 1 | 7.81 | 12.56 |
| | WP + Siloxane | | | |
| | Polyalkyleneoxide | | | |
| | Copolymer | | | |

*PDI: Percent Disease Index

TABLE D
Bio-efficacy of different surfactants with standard fungicide
Azoxystrobin 23 SC against early blight control on tomatoes

| | | | PDI* of | |
|---|---|---|---|---|
| | | Dose | Early Blight | |
| Sr. | | Formulation | Control On Tomato | |
| No. | Treatments | (ml/g) | Test 1 | Test 2 |
| 1 | Untreated control | — | 26.00 | 30.30 |
| 2 | Azoxystrobin 23 SC | 1.00 | 12.94 | 21.50 |
| 3 | Azoxystrobin 23 SC + | 1.00 + 1 | 3.56 | 6.06 |
| | Dioctyl sulfosuccinate | | | |
| 4 | Azoxystrobin 23 SC + | 1.00 + 1 | 6.94 | 13.06 |
| | alkoxylated glyceride #1 | | | |
| 5 | Azoxystrobin 23 SC + | 1.00 + 1 | 9.94 | 17.63 |
| | alkoxylated glyceride #2 | | | |
| 6 | Azoxystrobin 23 SC + | 1.00 + 1 | 12.13 | 21.19 |
| | Siloxane Polyalkyleneoxide | | | |
| | Copolymer | | | |

*PDI: Percent Disease Index

Percent Disease Index (PDI) for powdery mildew, downy mildew, anthracnose and early blight diseases were calculated by following formulae:

$$PDI = \frac{Sum of numerical ratings \times 100}{Number of leaves observed \times Maximum of rating scale}$$

In case of grapes ratings on minimum ten leaves and a bunch were recorded on randomly selected canes. Ten such canes per plant were observed. The observations on 8 plants spread over four replication were recorded. Thus, the data presented on PDI is average of randomly selected 80 canes.

In case of tomatoes ten plants from each replication except the border rows were taken at the beginning of each spray and 15 days after the second spray and scored.

The data set forth herein related to fungicide use with alkoxylated glyceride #1 and #2 demonstrate excellent results that surprisingly outperform the control and the Siloxane Polyalkyleneoxide Copolymer.

The alkoxylated glyceride #1 is demonstrated to be the best compound in 1 of 4 fungicide formulations, and second to best in the other 3, thereby outperforming It outperforms the Siloxane Polyalkyleneoxide Copolymer in all cases. The alkoxylated glyceride #2 also out performs the Siloxane Polyalkyleneoxide Copolymer in all cases.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A liquid agrochemical composition comprising:
an agrochemical comprising a fungicide and/or an herbicide chosen from dicamba, 2,4-D, glufosinate, and combinations thereof and present in an amount of from about 0.05 to about 60 weight percent based on a total weight of said composition; and
a surfactant present in an amount of from about 0.05 to about 50 weight percent based on a total weight of said composition and consisting of;
(i) at least one alkoxylated monoglyceride present in an amount of from about 30 to about 45 weight percent based on a total weight of said surfactant,
(ii) at least one alkoxylated diglyceride present in an amount of from about 40 to about 50 weight percent based on a total weight of said surfactant,
(iii) at least one alkoxylated triglyceride present in an amount of from about 8 to about 10 weight percent based on a total weight of said surfactant, and
(iv) at least one alkoxylated glycerin present in an amount of from about 6 to about 8 weight percent based on a total weight of said surfactant.

2. The composition of claim 1 wherein:
(i) said at least one alkoxylated monoglyceride has a structure: 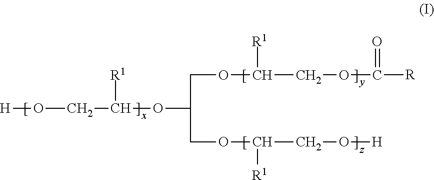
said at least one alkoxylated diglyceride has a structure: 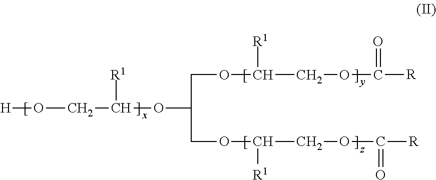
(iii) said at least one alkoxylated triglyceride has a structure: 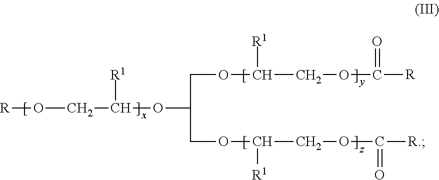
and
(iv) said at least one alkoxylated glycerin has a structure: 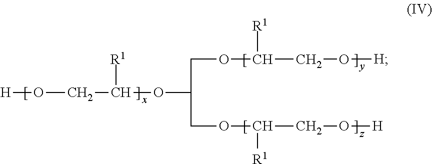
wherein each R is independently a C7-C23 saturated or unsaturated group;
wherein each R¹ is independently H, CH₃, or CH₂CH₃;
wherein a total of (x+y+z) is from about 2 to about 40.

3. The composition of claim 1, that is an in-can composition, wherein
said agrochemical is the herbicide;
said herbicide is present in an amount of from about 15 to about 60 weight percent based on a total weight of said composition; and
said surfactant is present in an amount of from about 5 to about 50 weight percent based on a total weight of said composition.

4. The composition of claim 1, that is a spray composition, wherein
said agrochemical is the herbicide;
said herbicide is present in an amount of from about 0.05 to about 5 weight percent based on a total weight of said composition; and
said surfactant is present in an amount of from about 0.05 to about 0.5 weight percent based on a total weight of said composition.

5. The composition of claim 1, that is an in-can composition, wherein
said agrochemical is the fungicide;
said herbicide is present in an amount of from about 15 to about 60 weight percent based on a total weight of said composition; and
said surfactant is present in an amount of from about 5 to about 50 weight percent based on a total weight of said composition.

6. The composition of claim 1, that is a spray composition, wherein
said agrochemical is the fungicide;
said herbicide is present in an amount of from about 0.05 to about 5 weight percent based on a total weight of said composition; and
said surfactant is present in an amount of from about 0.05 to about 0.5 weight percent based on a total weight of said composition.

7. The composition of claim 1 wherein each R¹ is H or CH₃.

8. The composition of claim 1 wherein:
(i) the at least one alkoxylated monoglyceride is present in an amount of from about 35 to about 37 weight percent based on a total weight of said surfactant,
(ii) the at least one alkoxylated diglyceride is present in an amount of from about 47 to about 49 weight percent based on a total weight of said surfactant,
(iii) the at least one alkoxylated triglyceride is present in an amount of from about 8.25 to about 8.75 weight percent based on a total weight of said surfactant, and
(iv) the at least one alkoxylated glycerin is present in an amount of from about 7.25 to about 7.75 weight percent based on a total weight of said surfactant.

9. The composition of claim 1 wherein a mole ratio of mono-glyceride to di-glyceride is about 1.2:1 to about 1.8:1.

10. The composition of claim 1 wherein a weight ratio of mono-glyceride to di-glyceride is about 0.74 to about 1.04.

11. The composition of claim 1 that is a spray composition, wherein said agrochemical is the glufosinate present in an amount of from about 0.05 to about 5 weight percent based on a total weight of said composition;
said surfactant is present in an amount of from about 0.05 to about 0.5 weight percent based on a total weight of said composition wherein each R¹ is H or CH₃, and
(i) the at least one alkoxylated monoglyceride is present in an amount of from about 35 to about 37 weight percent based on a total weight of said surfactant,
(ii) the at least one alkoxylated diglyceride is present in an amount of from about 47 to about 49 weight percent based on a total weight of said surfactant,
(iii) the at least one alkoxylated triglyceride is present in an amount of from about 8.25 to about 8.75 weight percent based on a total weight of said surfactant, and
(iv) the at least one alkoxylated glycerin is present in an amount of from about 7.25 to about 7.75 weight percent based on a total weight of said surfactant.

12. The composition of claim 1 that is an in-can composition, wherein said agrochemical is the glufosinate present in an amount of from about 15 to about 60 weight percent based on a total weight of said composition;
said surfactant is present in an amount of from about 5 to about 50 weight percent based on a total weight of said composition wherein each R¹ is H or CH₃, and
(i) the at least one alkoxylated monoglyceride is present in an amount of from about 35 to about 37 weight percent based on a total weight of said surfactant,
(ii) the at least one alkoxylated diglyceride is present in an amount of from about 47 to about 49 weight percent based on a total weight of said surfactant,
(iii) the at least one alkoxylated triglyceride is present in an amount of from about 8.25 to about 8.75 weight percent based on a total weight of said surfactant, and
(iv) the at least one alkoxylated glycerin is present in an amount of from about 7.25 to about 7.75 weight percent based on a total weight of said surfactant.

13. The composition of claim 1 that is a spray composition, wherein said agrochemical is the dicamba present in an amount of from about 0.05 to about 5 weight percent based on a total weight of said composition;
said surfactant is present in an amount of from about 0.05 to about 0.5 weight percent based on a total weight of said composition wherein each R¹ is H or CH₃, and
(i) the at least one alkoxylated monoglyceride is present in an amount of from about 35 to about 37 weight percent based on a total weight of said surfactant,
(ii) the at least one alkoxylated diglyceride is present in an amount of from about 47 to about 49 weight percent based on a total weight of said surfactant,
(iii) the at least one alkoxylated triglyceride is present in an amount of from about 8.25 to about 8.75 weight percent based on a total weight of said surfactant, and
(iv) the at least one alkoxylated glycerin is present in an amount of from about 7.25 to about 7.75 weight percent based on a total weight of said surfactant.

14. The composition of claim 1 that is an in-can composition, wherein said agrochemical is the dicamba present in an amount of from about 15 to about 60 weight percent based on a total weight of said composition;
said surfactant is present in an amount of from about 5 to about 50 weight percent based on a total weight of said composition wherein each R¹ is H or CH₃, and
(i) the at least one alkoxylated monoglyceride is present in an amount of from about 35 to about 37 weight percent based on a total weight of said surfactant,
(ii) the at least one alkoxylated diglyceride is present in an amount of from about 47 to about 49 weight percent based on a total weight of said surfactant,
(iii) the at least one alkoxylated triglyceride is present in an amount of from about 8.25 to about 8.75 weight percent based on a total weight of said surfactant, and
(iv) the at least one alkoxylated glycerin is present in an amount of from about 7.25 to about 7.75 weight percent based on a total weight of said surfactant.

15. The composition of claim 1 that is a spray composition, wherein said agrochemical is the 2,4-D present in an amount of from about 0.05 to about 5 weight percent based on a total weight of said composition;
said surfactant is present in an amount of from about 0.05 to about 0.5 weight percent based on a total weight of said composition wherein each R¹ is H or CH₃, and
(i) the at least one alkoxylated monoglyceride is present in an amount of from about 35 to about 37 weight percent based on a total weight of said surfactant,
(ii) the at least one alkoxylated diglyceride is present in an amount of from about 47 to about 49 weight percent based on a total weight of said surfactant,
(iii) the at least one alkoxylated triglyceride is present in an amount of from about 8.25 to about 8.75 weight percent based on a total weight of said surfactant, and
(iv) the at least one alkoxylated glycerin is present in an amount of from about 7.25 to about 7.75 weight percent based on a total weight of said surfactant.

16. The composition of claim 1 that is an in-can composition, wherein said agrochemical is the 2,4-D present in an amount of from about 15 to about 60 weight percent based on a total weight of said composition;
said surfactant is present in an amount of from about 5 to about 50 weight percent based on a total weight of said composition wherein each R¹ is H or CH₃, and
(i) the at least one alkoxylated monoglyceride is present in an amount of from about 35 to about 37 weight percent based on a total weight of said surfactant,
(ii) the at least one alkoxylated diglyceride is present in an amount of from about 47 to about 49 weight percent based on a total weight of said surfactant,
(iii) the at least one alkoxylated triglyceride is present in an amount of from about 8.25 to about 8.75 weight percent based on a total weight of said surfactant, and
(iv) the at least one alkoxylated glycerin is present in an amount of from about 7.25 to about 7.75 weight percent based on a total weight of said surfactant.

17. A liquid agrochemical composition consisting essentially of:
an agrochemical comprising a fungicide and/or an herbicide chosen from dicamba, 2,4-D, glufosinate, and combinations thereof and present in an amount of from about 0.05 to about 60 weight percent based on a total weight of said composition; and
a surfactant present in an amount of from about 0.05 to about 50 weight percent based on a total weight of said composition and consisting of;
(i) at least one alkoxylated monoglyceride present in a molar amount of from about 30 to about 45 weight percent of said surfactant and has a structure 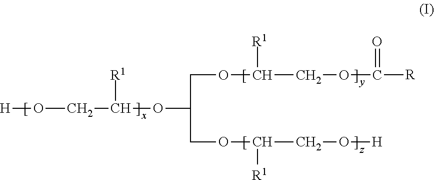
(ii) at least one alkoxylated diglyceride present in a molar amount of from about 40 to about 50 weight percent based on a total number of moles of (i)-(iv) in said surfactant and has a structure 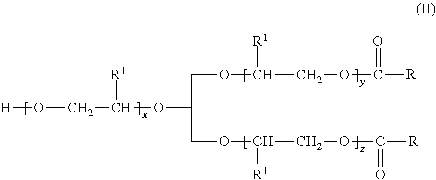
(iii) at least one alkoxylated triglyceride present in a molar amount of from about 8 to about 10 weight percent based on a total number of moles of (i)-(iv) in said surfactant and has a structure 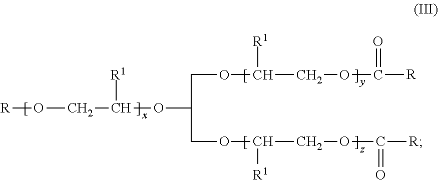
and
(iv) at least one alkoxylated glycerin present in a molar amount of from about 6 to about 8 weight percent based on a total number of moles of (i)-(iv) in said surfactant and has a structure 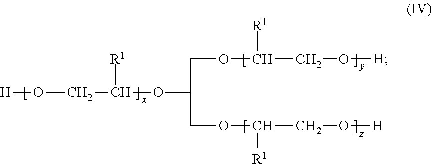
wherein each R is independently a C7-C23 saturated or unsaturated group;
wherein each R¹ is independently H, CH₃, or CH₂CH₃; and
wherein a total of (x+y+z) is from about 2 to about 40.

18. The composition of claim 17 wherein the agrochemical is a fungicide.

19. The composition of claim 17 wherein the agrochemical is 2.4-D.

20. The composition of claim 17 wherein the agrochemical is glufosinate.
